(19) United States
(12) Patent Application Publication
(10) Pub. No.: US 2025/0225575 A1
(43) Pub. Date: Jul. 10, 2025

(54) MONITORING APPARATUS, MONITORING METHOD, AND NON-TRANSITORY COMPUTER-READABLE STORAGE MEDIUM

(71) Applicant: NEC Corporation, Minato-ku, Tokyo (JP)

(72) Inventors: Yohei SUGIYAMA, Tokyo (JP); Yuya HANZAWA, Tokyo (JP)

(73) Assignee: NEC Corporation, Minato-ku, Tokyo (JP)

(21) Appl. No.: 18/844,423

(22) PCT Filed: Mar. 18, 2022
(86) PCT No.: PCT/JP2022/012611

§ 371 Date: Sep. 6, 2024

(51) Int. Cl. G06Q 40/02

(52) U.S. Cl. CPC G06Q 40/02

(57) ABSTRACT

A monitoring apparatus (100) includes: an input unit (102) that inputs past transaction information, customer information being information about a customer, and account information being information about an account that are in a financial transaction; a generation unit (104) that, by using the transaction information, the customer information, and the account information that are input by the input unit (102), generates unauthorized transaction information being information about an unauthorized transaction by using a trained model; and an output unit (106) that outputs the unauthorized transaction information generated by the generation unit (104), wherein the unauthorized transaction information includes at least one of an unauthorized transaction score by account and an unauthorized transaction score by customer.

### TECHNICAL FIELD

The present invention relates to a monitoring system, a monitoring apparatus, a monitoring method, and a storage medium.

### BACKGROUND ART

In recent years, transactions suspected of being unauthorized acts in financial transactions tend to increase. Therefore, enhanced monitoring of account transactions is desired.

Patent Document 1 describes an example of a transaction monitoring system performing monitoring of an account transaction. The system in Patent Document 1 includes an acquisition unit, a computation unit, and a determination unit and provides assistance in accurately determining whether a transaction is a suspicious one even when the determination is complex by, for example, causing a person in charge with a high skill level to make a determination when a degree of difficulty of the determination is high.

Patent Document 2 describes an unauthorized financial transaction detection program detecting an unauthorized financial transaction. The program described in Patent Document 2 causes a computer to execute: an information acquisition step of acquiring transaction information about a transaction history in a bank account of a new detection target person whose unauthorized transaction is to be newly detected; and a decision step of deciding a possibility of an unauthorized transaction by the new detection target person, based on the transaction information acquired in the information acquisition step, with reference to a degree of linkage in three or more stages between reference transaction information about a previously acquired transaction history in a bank account of a past detection target person and a possibility of an unauthorized transaction by the past detection target person.

### RELATED DOCUMENTS

### Patent Documents

Patent Document 1: Japanese Patent Application Publication No. 2019-61548
Patent Document 2: Japanese Patent Application Publication No. 2021-144355

### SUMMARY OF INVENTION

### Technical Problem

In each of the technologies described in Patent Documents described above, a score for a “suspicious transaction” or an “unauthorized financial transaction” is computed, and an unauthorized financial transaction is detected on a per transaction basis. Therefore, each of the technologies described in Patent Documents described above does not assume detecting an unauthorized act in a financial transaction on a per account basis or on a per customer basis. On the other hand, with regard to an unauthorized act in a financial transaction that cannot be detected when detection is performed on a per transaction basis, the present inventor has examined detecting such an unauthorized act in a financial transaction on a per account basis or on a per customer basis.

An example of an object of the present invention is to, in view of the issue described above, provide a monitoring system, a monitoring apparatus, a monitoring method, and a storage medium that resolve the issue of inability to detect an unauthorized act in a financial transaction when detection is performed on a per transaction basis.

### Solution to Problem

An example aspect of the present invention provides a monitoring apparatus including:
an input unit that inputs past transaction information, customer information being information about a customer, and account information being information about an account that are in a financial transaction;
a generation unit that, by using the transaction information, the customer information, and the account information that are input by the input unit, generates unauthorized transaction information being information about an detect an unauthorized transaction by using a trained model; and
an output unit that outputs the unauthorized transaction information generated by the generation unit, wherein
the unauthorized transaction information includes at least one of an unauthorized transaction score by account and an unauthorized transaction score by customer.

An example aspect of the present invention provides a monitoring system including:
an input unit that inputs past transaction information, customer information being information about a customer, and account information being information about an account that are in a financial transaction;
a generation unit that, by using the transaction information, the customer information, and the account information that are input by the input unit, generates unauthorized transaction information being information about an unauthorized transaction by using a trained model; and
an output unit that outputs the unauthorized transaction information generated by the generation unit, wherein
the unauthorized transaction information includes at least one of an unauthorized transaction score by account and an unauthorized transaction score by customer.

An example aspect of the present invention provides a monitoring method including, by one or more computers:
inputting past transaction information, customer information being information about a customer, and account information being information about an account that are in a financial transaction;
by using the input transaction information, the input customer information, and the input account information, generating unauthorized transaction information being information about an unauthorized transaction by using a trained model; and
outputting the generated unauthorized transaction information, wherein
the unauthorized transaction information includes at least one of an unauthorized transaction score by account and an unauthorized transaction score by customer.

An example aspect of the present invention provides a computer-readable storage medium on which a program is stored, the program causing a computer to execute:
a procedure for inputting past transaction information, customer information being information about a customer, and account information being information about an account that are in a financial transaction;
a procedure for, by using the transaction information, the customer information, and the account information that are input by the input unit generating unauthorized transaction information being information about an unauthorized transaction by using a trained model; and
a procedure for outputting the unauthorized transaction information generated by the generation unit, wherein
the unauthorized transaction information includes at least one of an unauthorized transaction score by account and an unauthorized transaction score by customer.

Note that another example aspect of the present invention may be a program causing at least one or more computers to execute the method according to the aforementioned example aspect or may be a storage medium readable by a computer on which such a program is recorded. The storage medium includes a non-transitory tangible medium.

The computer program includes a computer program code causing a computer to execute the monitoring method on a monitoring apparatus when being executed by the computer.

Note that any combination of the components described above, and representations of the present invention converted between a method, an apparatus, a system, a storage medium, a computer program, and the like are also valid as example aspects of the present invention.

Further, various components of the present invention do not necessarily need to be individually independent, and for example, a plurality of components may be formed as a single member, a plurality of members may form a single component, a certain component may be part of another component, and part of a certain component may overlap with part of another component.

Further, while a plurality of procedures are described in a sequential order in the method and the computer program according to the present invention, the order of description does not limit the order of execution of the plurality of procedures. Therefore, when the method and the computer program according to the present invention are executed, the order of the plurality of procedures may be changed without affecting the contents.

Furthermore, a plurality of procedures in the method and the computer program according to the present invention are not limited to be executed at timings different from each other. Therefore, for example, a certain procedure may be generated during execution of another procedure, and an execution timing of a certain procedure and an execution timing of another procedure may overlap with each other in part or in whole.

### Advantageous Effects of Invention

The example aspects of the present invention provide a monitoring system, a monitoring apparatus, a monitoring method, and a storage medium that resolve the issue of inability to detect an unauthorized act in a financial transaction when detection is performed on a per transaction basis.

### BRIEF DESCRIPTION OF THE DRAWINGS

FIG. 1 It is a diagram illustrating an overview of a monitoring apparatus according to an example embodiment.

FIG. 2 It is a flowchart illustrating an operation example of the monitoring apparatus according to the present example embodiment.

FIG. 3 It is a diagram conceptually illustrating a system configuration of a monitoring system according to an example embodiment.

FIG. 4 It is a block diagram illustrating a hardware configuration of a computer implementing a monitoring apparatus.

FIG. 5 It is a diagram illustrating a data structure example of transaction information.

FIG. 6 It is a diagram illustrating a data structure example of customer information.

FIG. 7 It is a diagram illustrating a data structure example of account information.

FIG. 8 It is a diagram illustrating a data structure example of an unauthorized transaction score.

FIG. 9 It is a diagram illustrating an example of an output screen of unauthorized transaction information.

FIG. 10 It is a diagram illustrating examples of a basis information output screen.

FIG. 11 It is a diagram illustrating an overview of a model generation apparatus according to an example embodiment.

FIG. 12 It is a flowchart illustrating an operation example of the model generation apparatus according to the present example embodiment.

FIG. 13 It is a diagram conceptually illustrating a system configuration of a monitoring system according to an example embodiment.

FIG. 14 It is a diagram illustrating a data example of intra-period transaction information being an example of secondary information.

FIG. 15 It is a functional block diagram illustrating a logical configuration example of a model generation apparatus according to an example embodiment.

FIG. 16 It is a diagram illustrating data examples of intra-period transaction information.

FIG. 17 It is a diagram illustrating a data example of intra-period transaction information indicating intra-period operation result information.

FIG. 18 It is a diagram illustrating a data structure example of secondary information including location comparison information.

FIG. 19 It is a diagram illustrating a data structure example of secondary information including transaction amount ratio information.

FIG. 20 It is a flowchart illustrating an operation example of the model generation apparatus according to the example embodiment.

FIG. 21 It is a diagram illustrating an overview of a model generation apparatus according to an example embodiment.

FIG. 22 It is a flowchart illustrating an operation example of the model generation apparatus according to the example embodiment.

FIG. 23 It is a diagram conceptually illustrating a system configuration of a monitoring system according to an example embodiment.

FIG. 24 It is a diagram illustrating a data structure of template information.

FIG. 25 It is a diagram illustrating an example of an import screen.

FIG. 26 It is a diagram illustrating an example of an input information selection screen.

FIG. 27 It is a diagram illustrating an example of a secondary information selection screen.

FIG. 28 It is a diagram illustrating a data structure example of template information.

FIG. 29 It is a diagram illustrating an example of a template selection screen.

FIG. 30 It is a flowchart illustrating an operation example of a model generation apparatus according to an example embodiment.

FIG. 31 It is a diagram illustrating a data structure example of the template information.

FIG. 32 It is a flowchart illustrating a main part of the operation example of the model generation apparatus according to the example embodiment.

### EXAMPLE EMBODIMENT

Example embodiments of the present invention will be described below by using drawings. Note that in every drawing, similar components are given similar signs, and description thereof is not included as appropriate. Further, in each of the following diagrams, a configuration of a part not related to the essence of the present invention is not included and is not illustrated.

In the example embodiments, “acquisition” includes at least one item out of an apparatus getting data or information stored in another apparatus or storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or storage medium. Further, examples of the passive acquisition include reception of distributed (or, for example, transmitted or push notified) information. Furthermore, “acquisition” may refer to selective acquisition from received data or information, or selective reception of distributed data or information.

### First Example Embodiment

### <Minimum Configuration Example>

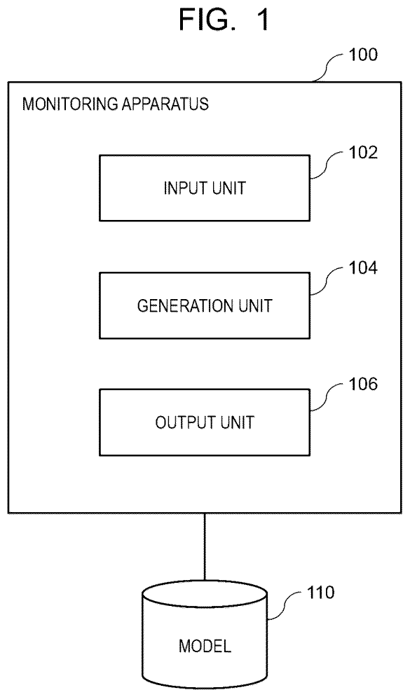

FIG. 1 is a diagram illustrating an overview of a monitoring apparatus 100 according to an example embodiment. The monitoring apparatus 100 includes an input unit 102, a generation unit 104, and an output unit 106.

The input unit 102 inputs past transaction information, customer information being information about a customer, and account information being information about an account that are in a financial transaction.

By using the transaction information, the customer information, and the account information that are input by the input unit 102, the generation unit 104 generates unauthorized transaction information being information about an unauthorized transaction by using a trained model.

The output unit 106 outputs the unauthorized transaction information generated by the generation unit 104.

The unauthorized transaction information includes at least one of an unauthorized transaction score by account and an unauthorized transaction score by customer.

### <Operation Example>

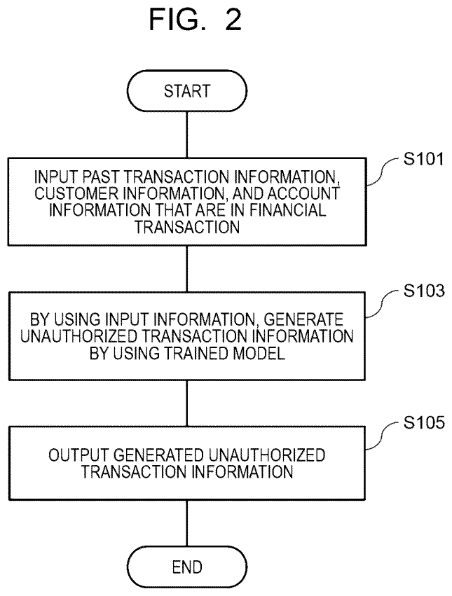

FIG. 2 is a flowchart illustrating an operation example of the monitoring apparatus 100 according to the present example embodiment.

First, the input unit 102 inputs past transaction information, customer information being information about a customer, and account information being information about an account that are in a financial transaction (Step S101). Then, by using the transaction information, the customer information, and the account information that are input by the input unit 102, the generation unit 104 generates unauthorized transaction information being information about an unauthorized transaction by using a trained model (Step S103). The output unit 106 outputs the unauthorized transaction information generated by the generation unit 104 (Step S105). The unauthorized transaction information includes at least one of an unauthorized transaction score by account and an unauthorized transaction score by customer.

The input unit 102 in the monitoring apparatus 100 inputs past transaction information, customer information being information about a customer, and account information being information about an account that are in a financial transaction. By using the transaction information, the customer information, and the account information that are input by the input unit 102, the generation unit 104 generates unauthorized transaction information being information about an unauthorized transaction by using a trained model. The output unit 106 outputs the unauthorized transaction information generated by the generation unit 104. Then, the unauthorized transaction information includes at least one of an unauthorized transaction score by account and an unauthorized transaction score by customer.

Thus, the monitoring apparatus 100 resolves the issue of inability to detect an unauthorized act in a financial transaction when detection is performed on a per transaction basis and provides a monitoring system, a monitoring apparatus, a monitoring method, and a storage medium that can detect an unauthorized act in a financial transaction on a per account basis or on a per customer basis.

Detailed examples of the monitoring apparatus 100 will be described below.

### Second Example Embodiment

### <System Overview>

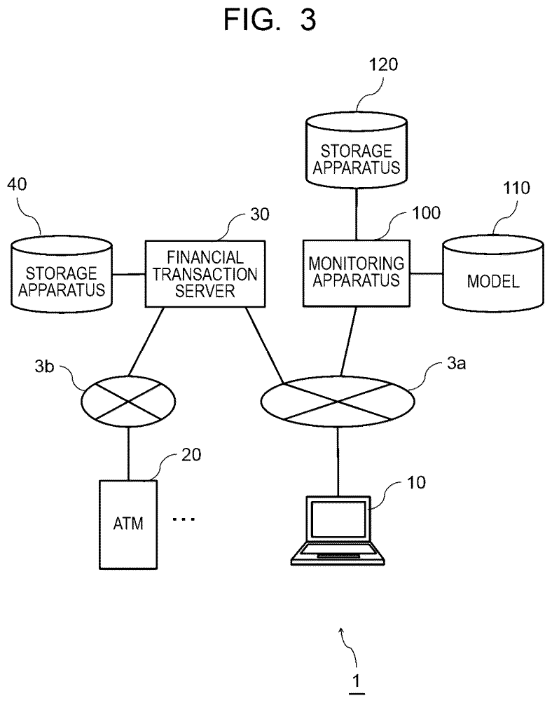

FIG. 3 is a diagram conceptually illustrating a system configuration of a monitoring system 1 according to an example embodiment.

The monitoring system 1 is a system monitoring a financial transaction by using a monitoring apparatus 100.

The monitoring system 1 includes the monitoring apparatus 100. The monitoring apparatus 100 monitors an unauthorized act in a financial transaction. The monitoring apparatus 100 is connected to a financial transaction server 30 through a communication network 3a.

While the communication network 3a may be configured with a combination of a plurality of networks, each network is assumed to be secure against external unauthorized access. The financial transaction server 30 is further connected to a plurality of ATMs 20 through a communication network 3b. The communication network 3b is a dedicated line for connecting to the financial transaction server 30 and is a network provided with sophisticated security measures.

The monitoring apparatus 100 includes a storage apparatus 120. The storage apparatus 120 stores various types of data input and processed by the monitoring apparatus 100. The monitoring apparatus 100 further includes a storage apparatus (unillustrated) that stores a model 110. The model 110 is a trained model for detecting an unauthorized act in a financial transaction. The storage apparatus storing the model 110 and the storage apparatus 120 may be provided inside the monitoring apparatus 100 or may be provided outside the monitoring apparatus 100. In other words, each of the storage apparatus for the model 110 and the storage apparatus 120 may be hardware integrated with the monitoring apparatus 100 or hardware separate from the monitoring apparatus 100.

Further, the model 110 is generated by a model generation apparatus 200 (or a model generation apparatus 300) according to an example embodiment to be described later.

The financial transaction server 30 may be provided for each financial institution and manages information about a financial transaction by the financial institution. The financial transaction server 30 includes a storage apparatus 40 storing information about a financial transaction by the financial institution. The storage apparatus 40 may be provided inside the financial transaction server 30 or may be provided outside the financial transaction server 30. In other words, the storage apparatus 40 may be hardware integrated with financial transaction server 30 or hardware separate from the financial transaction server 30.

Information about financial transactions at a plurality of ATMs 20 is transmitted to the financial transaction server 30 in a financial institution related to the financial transactions through the communication network 3b and is stored into the storage apparatus 40.

The monitoring apparatus 100 is implemented by a personal computer or a server computer. The financial transaction server 30 may be implemented by a server computer or the like; however, the financial transaction server 30 is a system on the financial institution side and therefore is not particularly limited in the present invention.

The monitoring system 1 may further include an operation terminal 10. The operation terminal 10 is connected to the monitoring apparatus 100 through the communication network 3a. The operation terminal 10 is a terminal used by a person in charge at a financial institution or an institution monitoring financial transactions. The operation terminal 10 is a personal computer or the like. The monitoring apparatus 100 can cause the operation terminal 10 to output a monitoring result of a financial transaction in the monitoring apparatus 100, such as a detection result of an unauthorized transaction.

### <Hardware Configuration Example>

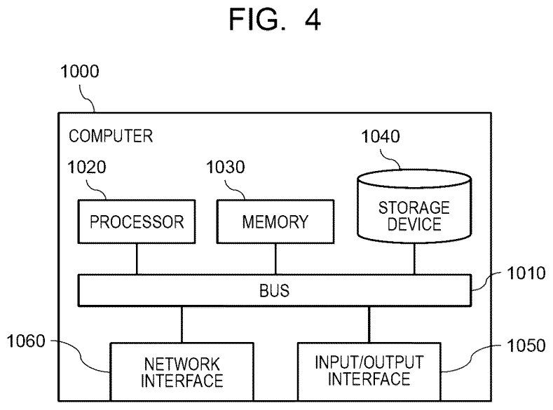

FIG. 4 is a block diagram illustrating a hardware configuration of a computer 1000 implementing the monitoring apparatus 100. Each of the financial transaction server 30 and the operation terminal 10 in FIG. 3 is also implemented by the computer 1000.

The computer 1000 includes a bus 1010, a processor 1020, a memory 1030, a storage device 1040, an input/output interface 1050, and a network interface 1060.

The bus 1010 is a data transmission channel for the processor 1020, the memory 1030, the storage device 1040, the input/output interface 1050, and the network interface 1060 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

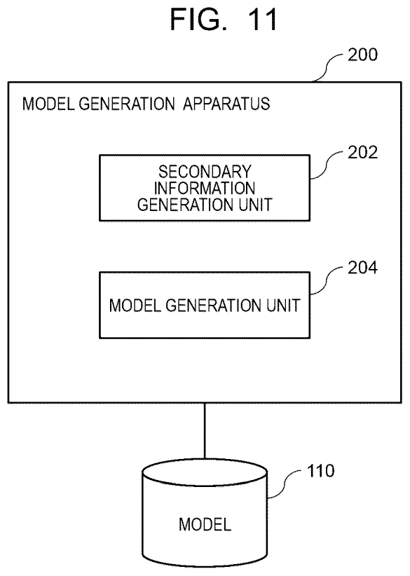

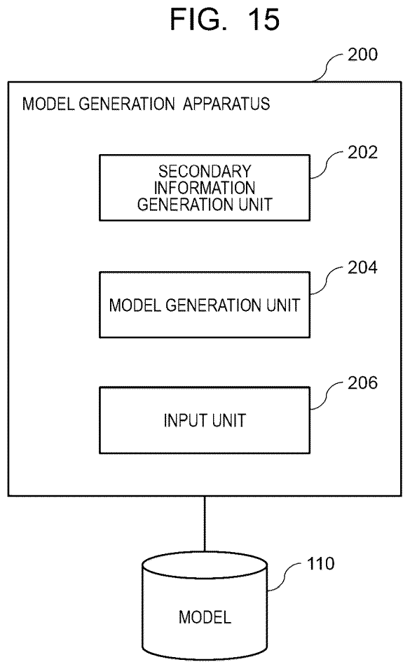

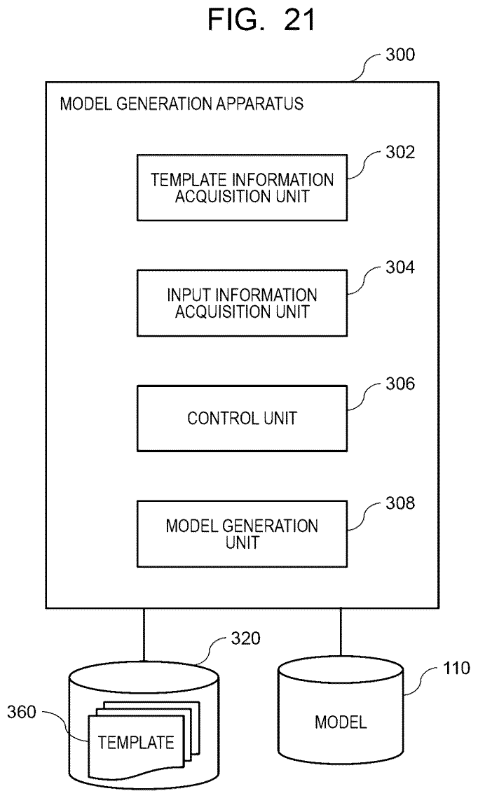

The storage device 1040 is an auxiliary storage provided by a hard disk drive (HDD), a solid-state drive (SSD), a memory card, a read-only memory (ROM), or the like. The storage device 1040 stores program modules for providing the functions of the monitoring apparatus 100 (such as the input unit 102, the generation unit 104, and the output unit 106 in FIG. 1), functions of a model generation apparatus 200 to be described later (such as a secondary information generation unit 202 and a model generation unit 204 in FIG. 11, and an input unit 206 in FIG. 15), or functions of a model generation apparatus 300 to be described later (such as a template information acquisition unit 302, an input information acquisition unit 304, a control unit 306, and a model generation unit 308 in FIG. 21). By reading each program module into the memory 1030 and executing the program module by the processor 1020, each function related to the program module is provided. Further, the storage device 1040 may also store data in the storage apparatus 120 in the monitoring apparatus 100, storage apparatuses for the model 110 in the monitoring apparatus 100, the model generation apparatus 200, and the model generation apparatus 300, and the storage apparatus 40 in the financial transaction server 30.

Each program module may be recorded on a storage medium. The storage medium on which the program module is recorded includes a non-transitory tangible medium usable to the computer 1000, and a program code readable by the computer 1000 (the processor 1020) may be embedded in the medium.

The input/output interface 1050 is an interface for connecting the computer 1000 to various types of input/output equipment. The input/output interface 1050 also functions as a communication interface for performing short-distance wireless communication such as Bluetooth (registered trademark) and/or near field communication (NFC).

The network interface 1060 is an interface for connecting the computer 1000 to a communication network. Examples of the communication network include a local area network (LAN) and a wide area network (WAN). The method for connecting the network interface 1060 to the communication network may be a wireless connection or a wired connection.

Then, the computer 1000 is connected to required equipment [such as a display of the monitoring apparatus 100 or the operation terminal 10, an operation unit (such as a keyboard, a mouse, a touch panel, or a touch pad), a speaker, a microphone, and a printer] through the input/output interface 1050 or the network interface 1060.

Each component in the monitoring apparatus 100 according to each example embodiment in FIG. 1, the model generation apparatuses 200 according to example embodiments in FIG. 11 and FIG. 15, and the model generation apparatus 300 in FIG. 21 is implemented by any combination of hardware and software of the computer 1000 in FIG. 4. Then, it is understood by a person skilled in the art that various modifications to the implementing method and the apparatus can be made. A functional block diagram illustrating each of the monitoring apparatus 100, the model generation apparatus 200, and the model generation apparatus 300 according to the example embodiments represents logical function-based blocks rather than a hardware-based configuration.

### Functional Configuration Example

A functional configuration example of the monitoring apparatus 100 according to the example embodiment will be described below by using FIG. 1.

The input unit 102 inputs past transaction information 400, customer information 410 being information about a customer, and account information 420 being information about an account that are in a financial transaction.

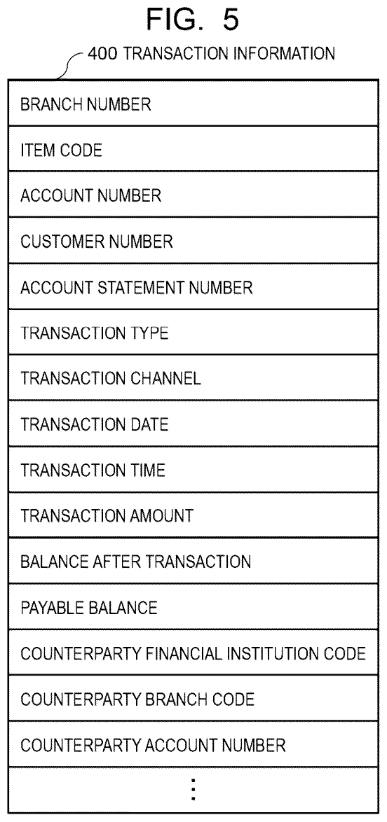

FIG. 5 is a diagram illustrating a data structure example of the transaction information 400.

For example, the transaction information 400 includes, by transaction, the branch number (branch code) of a branch holding an account, an item code indicating an item (such as an ordinary savings account or an checking account), and an account number that allow determination of an account in which the transaction has occurred, the customer number of a customer holding the account in which the transaction has occurred, an account statement number allowing determination of the transaction, the transaction type (such as cash payment or transfer payment) of the transaction, a transaction channel indicating a channel (such as a branch window; an ATM, or internet banking) of the transaction, the date on which the transaction is executed (a transaction date), the time, the transaction amount of the transaction, the balance remaining in the account in which the transaction has occurred, a payable balance indicating a payment limit applied to the transaction account, and a counterparty financial institution code, a counterparty branch code, and a counterparty account number that allow determination of an account of the remittee of the transaction.

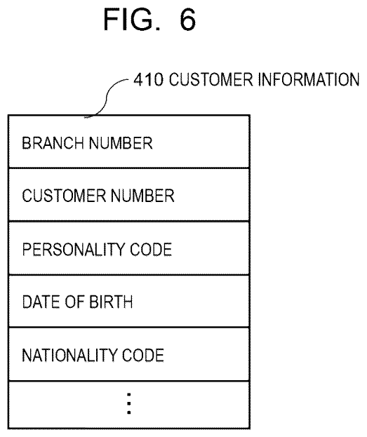

FIG. 6 is a diagram illustrating a data structure example of the customer information 410.

The customer information 410 includes the branch number (the branch code) of a branch holding an account in which a transaction included in the transaction information 400 has occurred, the customer number of a customer holding the account in which the transaction has occurred, a personality code indicating the personality (such as an individual, a corporation, a financial institution, public money, or a sole proprietor) of the customer, the date of birth of the customer holding the account, the nationality of the customer holding the account, and the like.

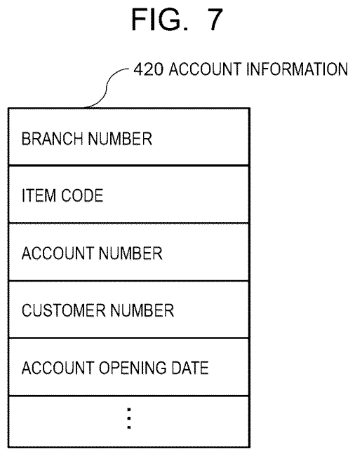

FIG. 7 is a diagram illustrating a data structure example of the account information 420.

The account information 420 includes the branch number (the branch code) of a branch holding an account in which a transaction included in the transaction information 400 has occurred, an item code indicating an item (such as an ordinary savings account or a checking account) of the account, the account number of the account, the customer number of a customer holding the account, and the opening date of the account.

As for the timing at which the input unit 102 accepts input of each piece of information, for example, the input may be accepted on a daily basis at a predetermined timing between after the end of business hours of one day and the start of business or input of the information for a predetermined days up to the previous business day (or in a predetermined period) may be collectively accepted at a predetermined timing including during business hours. The pieces of information input by the input unit 102 are stored into the storage apparatus 120 as the transaction information 400, the customer information 410, and the account information 420, respectively:

By using the transaction information 400, the customer information 410, and the account information 420 that are input by the input unit 102, the generation unit 104 generates unauthorized transaction information 430 being information about an unauthorized transaction by using a trained model 110.

The unauthorized transaction information 430 includes a score indicating an unauthorized transaction. At least one score out of a score by transaction, a score by account, and a score by customer is generated as a score. In particular, the unauthorized transaction information 430 preferably includes at least one of an unauthorized transaction score by account and an unauthorized transaction score by customer. The generated unauthorized transaction information 430 is stored into the storage apparatus 120.

A score is at least one of a value indicating whether the transaction is unauthorized and a value indicating a likelihood of the transaction being unauthorized; and for example, in a case where a score is indicated by a numerical value in a range of 0 to 100, the score may indicate that the possibility of the transaction being unauthorized decreases as the score gets closer to 0, and the possibility of the transaction being unauthorized increases as the score gets closer to 100. Alternatively, a positive or negative value may be used as a score; and the score may indicate that the possibility of the transaction being unauthorized increases in a case where the score is a negative value, and the possibility of the transaction being unauthorized decreases in a case where the score is a positive value.

A standard of an unauthorized transaction score may be changed depending on whether an account in which the transaction has occurred or a customer is corporate or individual.

For example, corporate transactions and individual transactions are separated, and scores are arranged in descending order in each population. In this case, a score in a case where a predetermined ratio (N %) of transactions from the top is extracted takes on a different value between the corporate transactions and the individual transactions. Thus acquired values may be used as the standard values for corporate and individual unauthorized transaction scores, respectively.

Examples of “an unauthorized act in a financial transaction” include a financial transaction with a prohibited client and a financial transaction for the purpose of an unauthorized act. An example of such a transaction is a financial transaction for the purpose of money laundering or financing to terrorism. In such a transaction, an account in another person's name may be bought and utilized for an unauthorized transaction. In such a case, status of depositing and payment may change suddenly before and after buying and selling of the account. A deposited amount and a paid amount may increase suddenly, or the number of times money is deposited and paid may increase suddenly. Alternatively, an account used for an unauthorized transaction is characterized by repeated depositing and payment in a short period.

The monitoring apparatus 100 predicts and scores existence of an unauthorized act in a financial transaction by using a trained model acquired by learning and modeling of such a characteristic of an unauthorized transaction. “Learning” in this case includes machine learning, deep learning, or the like.

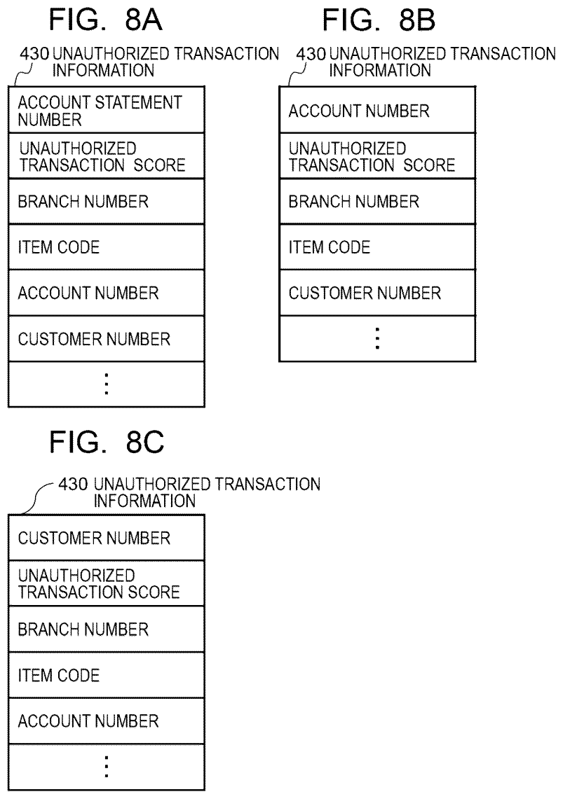

FIG. 8 is a diagram illustrating a data structure example of each unauthorized transaction score. FIG. 8(a), FIG. 8(b), and FIG. 8(c) illustrate data structure examples of unauthorized transaction information 430 by transaction, unauthorized transaction information 430 by account, and unauthorized transaction information 430 by customer, respectively.

At least an account statement number allowing determination of a transaction and an unauthorized transaction score are associated with each other in the unauthorized transaction information 430 by transaction in FIG. 8(a). The unauthorized transaction information 430 by transaction may further include the branch number of a branch holding an account in which the transaction has occurred, the item code of the account, the account number of the account, and the customer number of a customer holding the account.

At least the account number of an account in which the transaction has occurred and an unauthorized transaction score are associated with each other in the unauthorized transaction information 430 by account in FIG. 8(b). The unauthorized transaction information 430 by account may further include the branch number of a branch holding the account in which the transaction has occurred, the item code of the account, and the customer number of a customer holding the account.

At least the customer number of a customer holding an account in which the transaction has occurred and an unauthorized transaction score are associated with each other in the unauthorized transaction information 430 by customer in FIG. 8(c). The unauthorized transaction information 430 by customer may further include the branch number of a branch holding the account in which the transaction has occurred, the item code of the account, and the account number of the account.

In a case where the unauthorized transaction information 430 by customer is determined, a customer matching the customer number of the customer holding an account in which the transaction has occurred is assumed to be the same person. Note that in a case where a transaction related to a customer is determined, the transaction may be determined to be a transaction related to the same customer in a case where not only the customer number of a customer holding an account in which the transaction has occurred but also all of or at least part of other attributes of the customer, such as pieces of information, such as the date of birth and the nationality of the customer, match. Alternatively, an account may be determined to be an account related to the same customer out of a plurality of accounts in a case where not only the customer number of a customer holding the account but also all of or at least part of other attributes of the customer, such as pieces of information, such as the date of birth and the nationality of the customer, match.

The output unit 106 outputs the unauthorized transaction information 430 generated by the generation unit 104. For example, the output unit 106 may cause a display of the monitoring apparatus 100 or a display of the operation terminal 10 to display a screen 500 indicating the unauthorized transaction information 430.

The operation terminal 10 is previously authorized to utilize the monitoring system 1, and a person in charge using the operation terminal 10 previously acquires account information for logging into the monitoring system 1 (such as a username and a password). Further, an application program for utilizing a service provided by the monitoring system 1 is preinstalled on the operation terminal 10, and by logging into the monitoring system 1 by using the account information after starting the program, “VIEW UNAUTHORIZED TRANSACTION INFORMATION 430” can be selected from a menu screen in the monitoring system 1, and the screen 500 can be displayed.

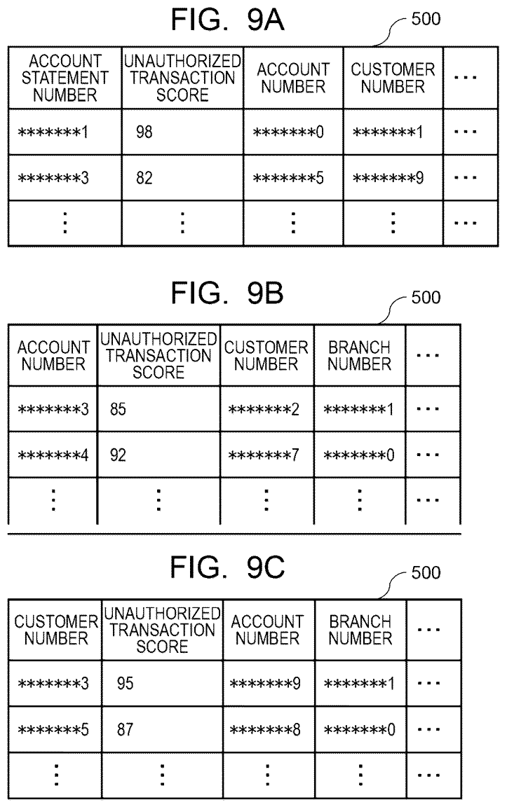

FIG. 9 is a diagram illustrating an example of an output screen 500 for each type of unauthorized transaction information 430. FIG. 9(a) is an output screen 500 for the unauthorized transaction information 430 by transaction, and for example, information about transactions each of which has a score equal to or greater than a threshold value is output in list form. For example, the list at least includes the account statement number of a transaction having a score equal to or greater than the threshold value and the value of the unauthorized transaction score. The list may further include the account number of an account in which the transaction has occurred and the customer number of a customer holding the account or may further include a counterparty account number, a counterparty customer number, and the like. Further, the risk may be sorted in descending order of the unauthorized transaction score.

FIG. 9(b) is an output screen 500 for the unauthorized transaction information 430 by account and, for example, at least includes the account number of an account having a score equal to or greater than the threshold value and the value of the unauthorized transaction score. The list may further include the customer number of a customer holding the account, the branch number of a branch holding the account, and the like. Further, the risk may be sorted in descending order of the unauthorized transaction score.

FIG. 9(c) is an output screen 500 for the unauthorized transaction information 430 by customer and, for example, at least includes the customer number of a customer having a score equal to or greater than the threshold value and the value of the unauthorized transaction score. The list may further include the account number of an account held by the customer and the branch number of a branch holding the account. Further, the risk may be sorted in descending order of the unauthorized transaction score.

The output unit 106 further outputs basis information being a basis of generation of each piece of unauthorized transaction information 430.

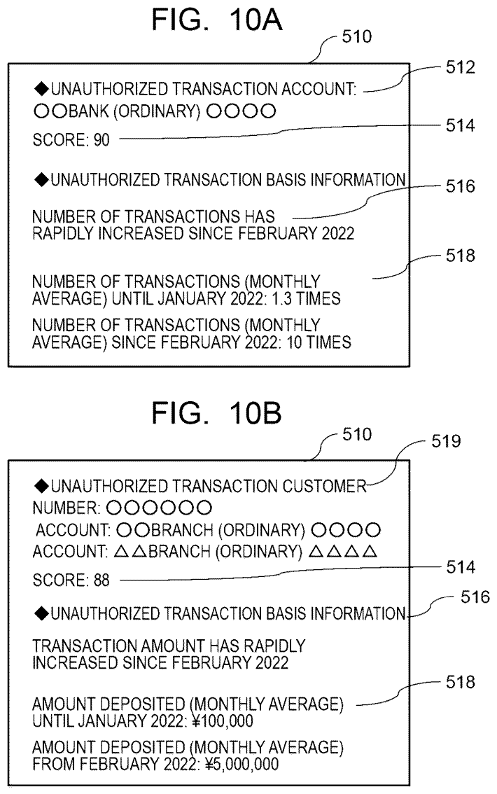

FIG. 10 is a diagram illustrating examples of a basis information output screen 510. FIG. 10(a) illustrates an example of the basis information output screen 510 including basis information of unauthorized transaction information 430 by account. The basis information output screen 510 includes, for an account having an unauthorized transaction score by account equal to or greater than a threshold value, an unauthorized transaction account information display part 512 displaying the account number of the account, a score display part 514 displaying the value of the unauthorized transaction score by account, a basis information display part 516 displaying basis information being a basis of the unauthorized act, and a source information display part 518 displaying information being a source of the basis information.

Basis information indicating that the number of transactions in the account has rapidly increased since a turn in February 2022 is displayed in the basis information display part 516 in this example.

FIG. 10(b) illustrates an example of the basis information output screen 510 including basis information of unauthorized transaction information 430. The basis information output screen 510 includes, for a customer having an unauthorized transaction score by customer equal to or greater than a threshold value, a customer information display part 519 displaying customer information including the customer number of the customer, information about at least one account held by the customer, such as the branch number of the account, an item, and the account number in place of the unauthorized transaction account information display part 512 in the basis information output screen 510 in FIG. 10(a) and also includes the score display part 514, the basis information display part 516, and the source information display part 518.

Basis information indicating that the transaction amount in the account held by the customer has rapidly increased since February 2022 is displayed in the basis information display part 516 in this example.

Thus, the output unit 106 outputs basis information being a basis of generation of each piece of unauthorized transaction information 430, and therefore, for a transaction output as a suspected unauthorized transaction, a person in charge can specifically confirm validity of the determination. Therefore, a burden of confirmation work on the person in charge can be lightened.

### <Operation Example>

An operation example of the monitoring apparatus 100 according to the example embodiment will be described below by using FIG. 2.

First, the input unit 102 inputs past transaction information 400, customer information 410 being information about a customer, and account information 420 being information about an account that are in a financial transaction at a predetermined timing (Step S101). The input transaction information 400, the input customer information 410, and the input account information 420 are stored into the storage apparatus 120.

Then, by using the transaction information 400, the customer information 410, and the account information 420 that are input by the input unit 102, the generation unit 104 generates unauthorized transaction information 430 being information about an unauthorized transaction by using the trained model 110 (Step S103). The unauthorized transaction information 430 includes at least either of unauthorized transaction information 430 by customer and unauthorized transaction information 430 by account. The unauthorized transaction information 430 may further include unauthorized transaction information 430 by transaction. Each piece of unauthorized transaction information 430 is stored into the storage apparatus 120.

Then, the output unit 106 outputs the unauthorized transaction information 430 generated by the generation unit 104 (Step S105). For example, the output unit 106 causes the display of the operation terminal 10 to display at least one of the screens 500 in FIG. 9(a) to FIG. 9(c). The output unit 106 may further cause the display of the operation terminal 10 to display at least one of the basis information output screens 510 in FIG. 10(a) and FIG. 10(b).

For example, when accepting a selection operation of a column for an account number while causing the display of the operation terminal 10 to display the screen 500 in FIG. 9(b), the output unit 106 may cause the display screen to make a transition from the screen 500 to the basis information output screen 510 for the unauthorized transaction information 430 by account in FIG. 10(a). Similarly, when accepting a selection operation of a column for a customer number while causing the display of the operation terminal 10 to display the screen 500 in FIG. 9(c), the output unit 106 may cause the display screen to make a transition from the screen 500 to the basis information output screen 510 for the unauthorized transaction information 430 by customer in FIG. 10(b).

As described above, the monitoring apparatus 100 according to the present example embodiment includes the input unit 102, the generation unit 104, and the output unit 106. The input unit 102 inputs past transaction information, customer information being information about a customer, and account information being information about an account that are in a financial transaction. By using the transaction information, the customer information, and the account information that are input by the input unit 102, the generation unit 104 generates unauthorized transaction information being information about an unauthorized transaction by using the trained model 110. The output unit 106 outputs the unauthorized transaction information generated by the generation unit 104. The unauthorized transaction information includes at least one of an unauthorized transaction score by account and an unauthorized transaction score by customer.

Thus, the monitoring apparatus 100 can resolve the issue of inability to detect an unauthorized act in a financial transaction when detection is performed on a per transaction basis and can detect an unauthorized act in a financial transaction on a per account basis or on a per customer basis.

Further, since unauthorized transaction information may also include unauthorized transaction information 430 by transaction, unauthorized acts in financial transactions can be exhaustively detected.

### Third Example Embodiment

FIG. 11 is a diagram illustrating an overview of a model generation apparatus 200 according to an example embodiment. The model generation apparatus 200 according to the present example embodiment generates a trained model 110 used by the monitoring apparatus 100 in FIG. 1. First, a minimum configuration example of the model generation apparatus 200 will be described.

### <Minimum Configuration Example>

The model generation apparatus 200 includes a secondary information generation unit 202 and a model generation unit 204.

The secondary information generation unit 202 generates secondary information contributing to improved performance of a model 110 detecting an unauthorized transaction in a financial transaction.

The model generation unit 204 generates a model 110 by using the secondary information generated by the secondary information generation unit 202.

### <Operation Example>

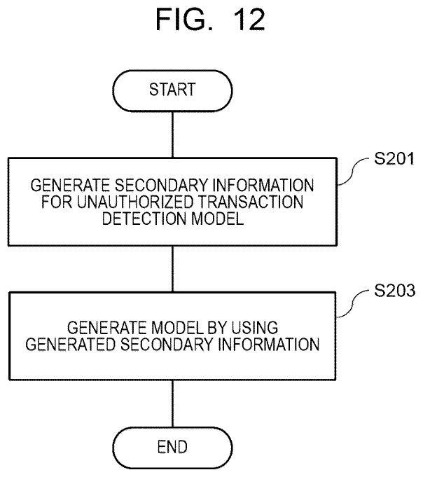

FIG. 12 is a flowchart illustrating an operation example of the model generation apparatus 200 according to the present example embodiment.

First, the secondary information generation unit 202 generates secondary information contributing to improved performance of a model 110 detecting an unauthorized transaction in a financial transaction (Step S201). Then, the model generation unit 204 generates a model 110 by using the secondary information generated by the secondary information generation unit 202 (Step S203).

The model generation apparatus 200 includes the secondary information generation unit 202 and the model generation unit 204. The secondary information generation unit 202 generates secondary information contributing to improved performance of a model 110 detecting an unauthorized transaction in a financial transaction. The model generation unit 204 generates a model 110 by using the secondary information generated by the secondary information generation unit 202.

Thus, the model generation apparatus 200 can generate a high-performance model 110 fitting the purpose of unauthorized act detection in a financial transaction.

Detailed examples of the model generation apparatus 200 will be described below.

### Fourth Example Embodiment

### <System Overview>

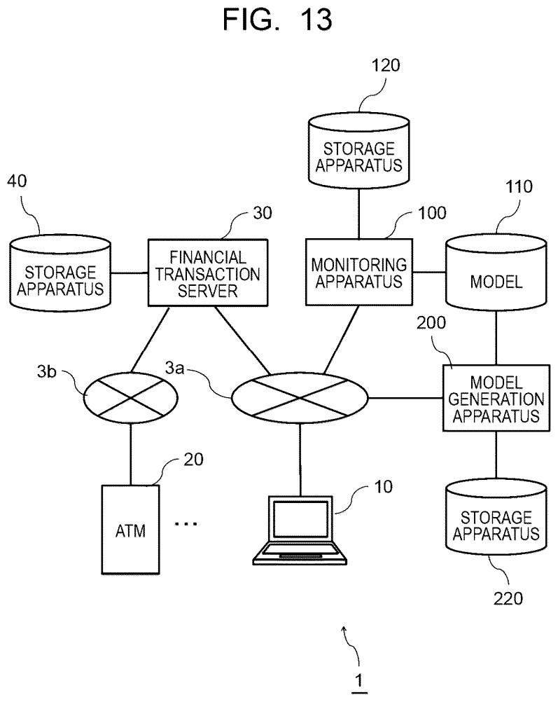

FIG. 13 is a diagram conceptually illustrating a system configuration of a monitoring system 1 according to an example embodiment. The monitoring system 1 in FIG. 13 further includes a model generation apparatus 200 in addition to the configuration of the monitoring system 1 in FIG. 3. The model generation apparatus 200 is connected to a financial transaction server 30 through a communication network 3a. Note that the configuration according to the present example embodiment may be combined with at least one of configurations according to other example embodiments without contradicting each other.

The model generation apparatus 200 includes a storage apparatus 220 and may also include a storage apparatus (unillustrated) that stores a model 110. The storage apparatus for the model 110 and the storage apparatus 220 may be provided inside the model generation apparatus 200 or may be provided outside the model generation apparatus 200. In other words, each of the storage apparatus for the model 110 and the storage apparatus 220 may be hardware integrated with the model generation apparatus 200 or hardware separate from the model generation apparatus 200.

The model generation apparatus 200 is implemented by a personal computer, a server computer, or the like.

### <Functional Configuration Example>

A functional configuration of the model generation apparatus 200 will be described below by using FIG. 11.

A secondary information generation unit 202 generates secondary information contributing to improved performance of a model 110 detecting an unauthorized transaction in a financial transaction. The secondary information includes information being an explanatory variable of a model 110 having existence of an unauthorized transaction in a financial transaction and a likelihood of the transaction being an unauthorized transaction as objective variables. For example, as described above, an account used for an unauthorized transaction is characterized by repeated depositing and payment in a short period. Therefore, a time difference between depositing and payment indicating transactions characterized by repeated depositing and payment in a short period, the number of times money is deposited per day, the number of times money is paid per day, and the like in a predetermined period are generated as secondary information. A model generation unit 204 can improve unauthorized transaction detection performance of a model 110 by generating the model 110, based on secondary information generated as explanatory variables of the model 110 having existence of an unauthorized act in a financial transaction and a likelihood of the transaction being an unauthorized transaction as objective variables.

Secondary information 440 includes intra-period transaction information 442 about a transaction content in a predetermined period.

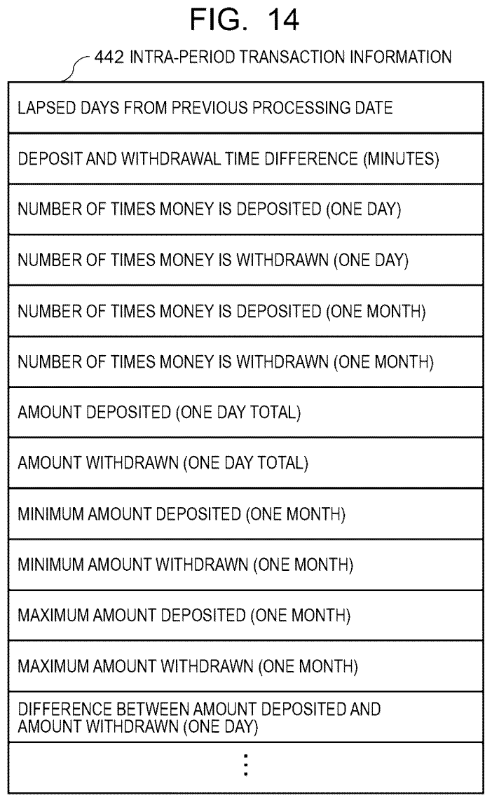

FIG. 14 is a diagram illustrating a data example of the intra-period transaction information 442 being an example of the secondary information 440. For example, the intra-period transaction information 442 is an example of days in a predetermined period and includes lapsed days from a previous processing date related to transaction information of a certain account or a certain customer, and the following information in the period. The processing date is a date when processing of generating the secondary information 440 is performed. The intra-period transaction information 442 includes at least one of a depositing-payment time difference indicating a time (minutes) from a time of depositing to a time of payment, the number of times money is deposited per day, the number of times money is paid per day; the number of times money is deposited in one month, the number of times money is paid in one month, a total amount deposited in one day; a total amount paid in one day, a minimum amount deposited in one month, a minimum amount paid in one month, a maximum amount deposited in one month, a maximum amount paid in one month, a difference between an amount deposited and an amount paid in one day; and the like.

The model generation unit 204 generates a model by using secondary information 440 generated by the secondary information generation unit 202. For example, the model generation unit 204 generates a model by using secondary information 440 including the intra-period transaction information 442.

As described above, the model 110 is a model for detecting existence of an unauthorized transaction in a financial transaction and a likelihood of the transaction being an unauthorized transaction. In other words, the secondary information 440 includes information to be an explanatory variable for effectively learning an unauthorized act pattern in a financial transaction. Various types of secondary information 440 other than those described above are conceivable, and variations thereof will be described in detail in an example embodiment to be described later.

### <Operation Example>

The operation of the model generation apparatus 200 according to the example embodiment will be described below by using FIG. 12.

First, the secondary information generation unit 202 generates secondary information 440 contributing to improved performance of a model detecting an unauthorized transaction in a financial transaction (Step S201). For example, the secondary information generation unit 202 generates the intra-period transaction information 442 illustrated in FIG. 14 as the secondary information 440. For example, the secondary information generation unit 202 may generate the intra-period transaction information 442 by using the transaction information 400 described in the aforementioned example embodiment (FIG. 5).

Then, the model generation unit 204 generates a model 110 by using the secondary information 440 generated by the secondary information generation unit 202 in Step S201 (Step S203).

The model 110 is generated by using the intra-period transaction information 442 indicating a characteristic of a transaction pattern of an unauthorized transaction and therefore can improve, in a financial transaction, performance of unauthorized act detection using the model 110.

As described above, the model generation apparatus 200 according to the present example embodiment includes the secondary information generation unit 202 and the model generation unit 204. The secondary information generation unit 202 generates secondary information contributing to improved performance of a model 110 detecting an unauthorized transaction in a financial transaction. The model generation unit 204 generates a model 110 by using the secondary information generated by the secondary information generation unit 202.

Thus, the model generation apparatus 200 can generate a high-performance model 110 fitting the purpose of unauthorized act detection in a financial transaction.

Further, the secondary information 440 includes intra-period transaction information about a transaction content in a predetermined period and therefore enables detection of an event suspected of an unauthorized act that cannot be detected from only one transaction. For example, a case of depositing and payment being frequently repeated in a short period can be detected as an unauthorized transaction.

### Fifth Example Embodiment

FIG. 15 is a functional block diagram illustrating a logical configuration example of a model generation apparatus 200 according to an example embodiment. The present example embodiment is the same as the fourth example embodiment except for including a configuration in which primary information used for generating secondary information is input. Note that the configuration according to the present example embodiment may be combined with at least one of configurations according to other example embodiments without contradicting each other.

### <Functional Configuration Example>

The model generation apparatus 200 includes a secondary information generation unit 202 and a model generation unit 204 that are the same as those in the model generation apparatus 200 in FIG. 11 and further includes an input unit 206.

The input unit 206 inputs past transaction information 400, customer information 410 being information about a customer, and account information 420 being information about an account.

The secondary information generation unit 202 generates secondary information 440, based on the transaction information 400, the customer information 410, and the account information 420 that are input by the input unit 206.

The model generation unit 204 generates a model 110 by using the transaction information 400, the customer information 410, and the account information 420 that are input by the input unit 206, and the secondary information 440 generated by the model generation unit 204.

The transaction information 400, the customer information 410, and the account information 420 are the same as the pieces of information according to the second example embodiment in FIG. 5, FIG. 6, and FIG. 7.

The secondary information generation unit 202 generates secondary information 440, based on at least two or more pieces of information out of the transaction information 400, the customer information 410, and the account information 420 that are input by the input unit 206.

The secondary information generation unit 202 generates secondary information 440, based on two or more types of information instead of one type of information and therefore can improve unauthorized act detection performance of the model 110 by using, in learning of the model 110, secondary information 440 better exhibiting a characteristic of a transaction pattern of an unauthorized transaction.

Other examples of secondary information 440 will be described below.

### Example 1: Period Client Information

Intra-period transaction information 442 in secondary information 440 may include period client information indicating whether a client of a certain transaction is different from a client group in a predetermined period.

### Example 2: Period Transaction Difference Information

Intra-period transaction information 442 in secondary information 440 may include period transaction difference information indicating the extent of the difference between a certain transaction content and a transaction content group in a predetermined period.

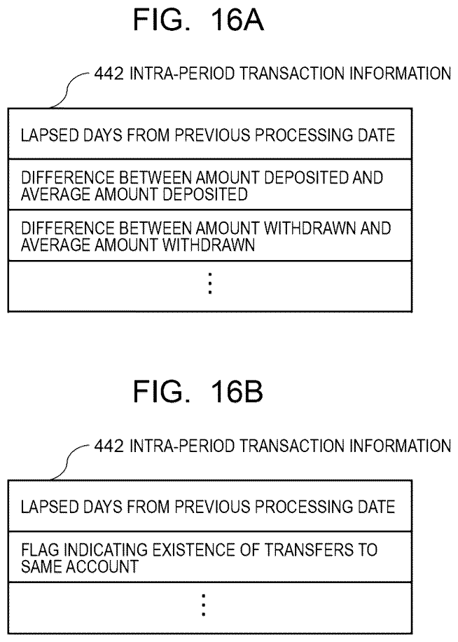

FIG. 16 is a diagram illustrating data examples of intra-period transaction information 442.

FIG. 16(a) illustrates an example of intra-period transaction information 442 indicating period transaction difference information. The intra-period transaction information 442 is an example of days in a predetermined period and includes lapsed days from the previous processing date related to transaction information of a certain account, and at least one of the difference between the average amount deposited per transaction in the period and an amount deposited in a certain transaction and the difference between the average amount paid per transaction in the period and an amount paid in a certain transaction.

Specifically, for example, in a case where the difference between an amount deposited and the average amount deposited per transaction is equal to or greater than a threshold value, the model generation unit 204 causes the model 110 to learn that the possibility of the transaction being an unauthorized transaction is high. Then, in a case where the difference between an amount deposited and the average amount deposited per transaction is equal to or greater than the threshold value in a case of the trained model 110 being used in the monitoring apparatus 100 according to the aforementioned example embodiment, an unauthorized act score indicating that the possibility of the transaction being an unauthorized transaction is high can be output.

FIG. 16(b) illustrates an example of intra-period transaction information 442 indicating period client information. The intra-period transaction information 442 is an example of days in a predetermined period in a certain account and includes lapsed days from the previous processing date related to transaction information of the certain account and a flag indicating whether clients of the account, such as payees from the account, in the period include the same account (a flag indicating existence of transfers to the same account). For example, 1 may be set to the flag in a case where transfers to the same account occur in the predetermined period, and 0 may be set to the flag in a case where transfers to the same account does not occur in the predetermined period.

For example, in a case where transfers to the same account occur (in other words, in a case where 1 is set to the flag indicating existence of transfers to the same account), the model generation unit 204 causes the model 110 to learn that the possibility of a transaction to the client in the account being an unauthorized transaction is high.

### Example 3: Intra-Period Operation Result Information

Intra-period transaction information 442 is intra-period operation result information indicating a result of an operation of a transaction apparatus in a predetermined period.

The transaction apparatus refers to an ATM 20. For example, a result of an operation of the transaction apparatus may include the number of erroneous operations at an ATM 20.

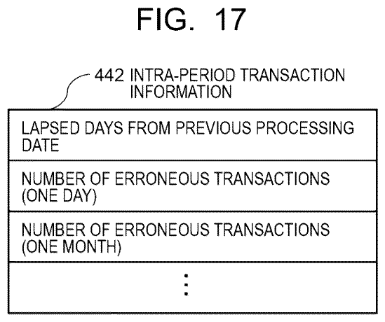

FIG. 17 is a diagram illustrating a data example of intra-period transaction information 442 indicating intra-period operation result information. The intra-period transaction information 442 includes lapsed days from the previous processing date related to transaction information of a certain account, the lapsed days indicating days in a predetermined period, and at least one of the number of erroneous operations at an ATM 20 per day and the number of erroneous operations at the ATM 20 in one month in the period.

For example, in a case where the number of occurrences of erroneous operations at an ATM 20 is greater than a threshold value in a transaction in a certain account, the model generation unit 204 causes the model 110 to learn that the possibility of the account being utilized for an unauthorized transaction is high. Then, in a case where the number of occurrences of erroneous operations at an ATM 20 is greater than the threshold value in a case of the trained model 110 being used in the monitoring apparatus 100 according to the aforementioned example embodiment, an unauthorized act score indicating that the possibility of the account being utilized for an unauthorized transaction is high can be output.

### Example 4: Location Comparison Information

Secondary information 440 is location comparison information indicating a comparison result of information indicating a location.

The information indicating a location is a location where a transaction is performed and, for example, is the branch number of a branch in a case where the transaction is performed at a window in the branch and is the branch number of a branch managing an ATM 20 in a case where the transaction is performed at the ATM 20. The location comparison information may be represented by a different branch processing flag indicating whether the branch number of a branch at which a transaction is performed and the branch number of a branch holding an account in which the transaction is performed are the same by comparing the branch numbers. Specifically, 1 is set to the different branch processing flag in a case where the transaction is performed at a branch different from the branch holding the account, and 0 is set to the different branch processing flag in a case where the transaction is performed at the same branch as the branch holding the account.

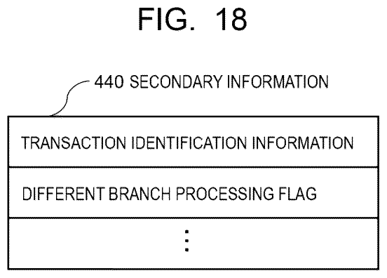

FIG. 18 is a diagram illustrating a data structure example of secondary information 440 including location comparison information.

The secondary information 440 includes transaction identification information allowing determination of a transaction and a different branch processing flag of the transaction. The secondary information 440 may further include information allowing determination of an account in which the transaction is performed (such as the branch number of a branch holding the account, the item code of the account, and the account number of the account).

Specifically, for example, in a case where 1 is set to the different branch processing flag of a certain transaction, the model generation unit 204 causes the model 110 to learn that the possibility of the transaction being an unauthorized transaction is high. Then, in a case where 1 is set to the different branch processing flag of a certain transaction in a case of the trained model 110 being used in the monitoring apparatus 100 according to the aforementioned example embodiment, an unauthorized act score indicating that the possibility of the transaction being an unauthorized transaction is high can be output.

### Example 5: Transaction Amount Ratio Information

Secondary information 440 may be transaction amount ratio information indicating the ratio of a transaction amount to a predetermined amount. The predetermined amount is at least one of the balance of an account in which a transaction has occurred, a deposited amount (or may be a direct deposit amount or the like) per month, and the average transaction amount per transaction in the previous month. In a case where the ratio of an amount of a certain transaction to the predetermined amount exceeds a threshold value, the transaction is an unauthorized transaction.

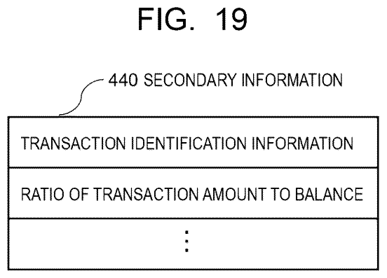

FIG. 19 is a diagram illustrating a data structure example of secondary information 440 including transaction amount ratio information. The secondary information 440 includes transaction identification information allowing determination of a transaction and transaction amount ratio information of the transaction. The secondary information 440 may further include information allowing determination of an account in which the transaction is performed (such as the branch number of a branch holding the account, the item code of the account, and the account number of the account).

Specifically, for example, in a case where the ratio of an amount of a certain transaction to a predetermined amount exceeds a threshold value, the model generation unit 204 causes the model 110 to learn that the possibility of the transaction being an unauthorized transaction is high. Then, in a case where the ratio of an amount of a certain transaction exceeds the threshold value in a case of the trained model 110 being used in the monitoring apparatus 100 according to the aforementioned example embodiment, an unauthorized act score indicating that the possibility of the transaction being an unauthorized transaction is high can be output.

### <Operation Example>

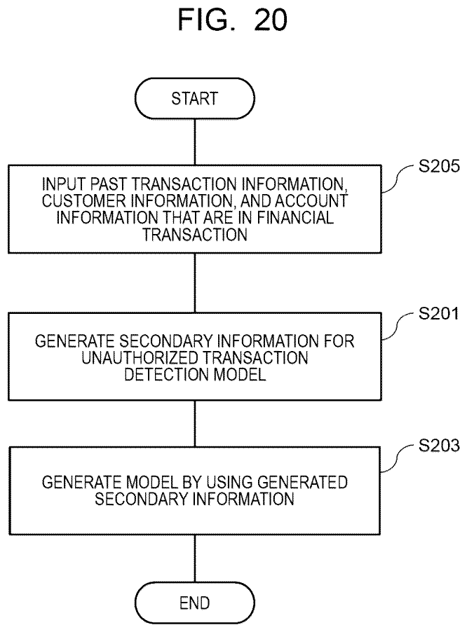

FIG. 20 is a flowchart illustrating an operation example of the model generation apparatus 200 according to the example embodiment.

The flow in FIG. 16 includes Step S201 and Step S203 that are the same as those in the flow in FIG. 12 and further includes Step S205 before Step S201.

First, the input unit 206 inputs past transaction information 400, customer information 410 being information about a customer, and account information 420 being information about an account (Step S205).

The secondary information generation unit 202 generates secondary information 440, based on the transaction information 400, the customer information 410, and the account information 420 that are input by the input unit 206 in Step S205 (Step S201).

The model generation unit 204 generates a model 110 by using the transaction information 400, the customer information 410, and the account information 420 that are input by the input unit 206 in Step S205 and the secondary information 440 generated by the model generation unit 204 in Step S201 (Step S203).

As described above, the model generation apparatus 200 according to the present example embodiment further includes the input unit 206 in addition to the configuration according to the aforementioned example embodiment. The input unit 206 inputs past transaction information 400, customer information 410 being information about a customer, and account information 420 being information about an account. Then, the secondary information generation unit 202 generates secondary information 440, based on the transaction information 400, the customer information 410, and the account information 420 that are input by the input unit 206, and the model generation unit 204 generates a model 110 by using the transaction information 400, the customer information 410, and the account information 420 that are input by the input unit 206 and the secondary information 440 generated by the model generation unit 204.

Thus, the model generation apparatus 200 according to the present example embodiment provides effects similar to those of the aforementioned example embodiments and further can generate secondary information 440, based on input transaction information 400, input customer information 410, and input account information 420 and therefore can generate a model 110 by generating the secondary information 440 to be explanatory variables for effectively learning unauthorized act patterns of various financial transactions. Therefore, performance of unauthorized act detection using the generated model 110 can be further improved in a financial transaction.

### Sixth Example Embodiment

FIG. 21 is a diagram illustrating an overview of a model generation apparatus 300 according to an example embodiment. The model generation apparatus 200 according to the present example embodiment is the same as the model generation apparatuses 200 in FIG. 11 and in FIG. 15 in generating a trained model used by the monitoring apparatus 100 in FIG. 1. The model generation apparatus 300 according to the present example embodiment differs from the aforementioned model generation apparatuses 200 in including a configuration in which a model 110 is generated by using a template when the model 110 is generated. In other words, the model generation apparatus 300 facilitates generation of a model 110 in the model generation apparatus 200 by using a template and enables improved performance of unauthorized act detection in a financial transaction. Note that the configuration according to the present example embodiment may be combined with at least one of configurations according to other example embodiments without contradicting each other.

### <Minimum Configuration Example>

The model generation apparatus 300 includes a template information acquisition unit 302, an input information acquisition unit 304, a control unit 306, and a model generation unit 308.

The template information acquisition unit 302 acquires template information used in generation of a model 110 detecting an unauthorized transaction in a financial transaction. The template information includes input information item definition information determining an item in each piece of input information used in generation of a model 110 and secondary information generation definition information determining a generation content of secondary information contributing to improved performance of the model 110 based on the input information.

For each item determined by the input information item definition information included in the template information, the input information acquisition unit 304 acquires input information corresponding to the item.

The control unit 306 controls a generation content of secondary information according to the secondary information generation definition information included in the template information.

The model generation unit 308 generates a model 110, based on the controlled generation content of the secondary information.

### <Operation Example>

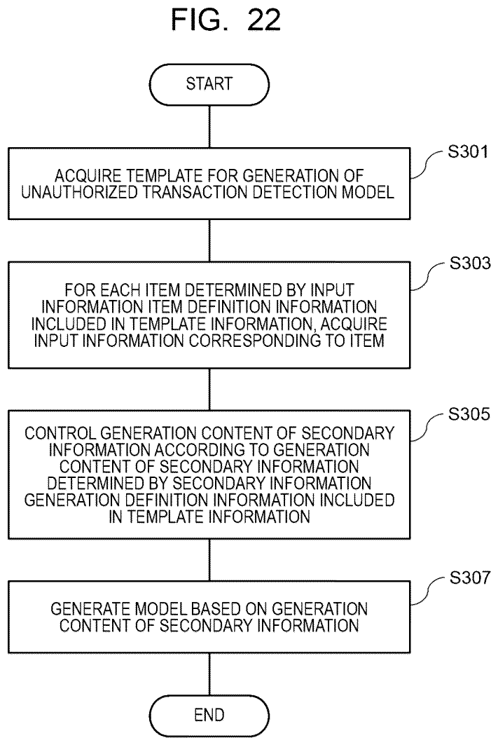

FIG. 22 is a flowchart illustrating an operation example of the model generation apparatus 300 according to the example embodiment. First, the template information acquisition unit 302 acquires template information used in generation of a model 110 detecting an unauthorized transaction in a financial transaction (Step S301). Then, for each item determined by input information item definition information included in the template information acquired in Step S301, the input information acquisition unit 304 acquires input information corresponding to the item (Step S303). The control unit 306 controls a generation content of secondary information according to secondary information generation definition information included in the template information acquired in Step S301 (Step S305). The model generation unit 308 generates a model 110, based on the generation content of the secondary information controlled in Step S305 (Step S307).

The model generation apparatus 300 includes the template information acquisition unit 302, the input information acquisition unit 304, the control unit 306, and the model generation unit 308. The template information acquisition unit 302 acquires template information used in generation of a model 110 detecting an unauthorized transaction in a financial transaction. The template information includes input information item definition information determining an item in each piece of input information used in generation of a model 110 and secondary information generation definition information determining a generation content of secondary information contributing to improved performance of the model 110 based on the input information. For each item determined by the input information item definition information included in the template information, the input information acquisition unit 304 acquires input information related to the item. The control unit 306 controls a generation content of secondary information according to the secondary information generation definition information included in the template information. The model generation unit 308 generates a model 110, based on the controlled generation content of the secondary information.

The model generation apparatus 300 can easily generate a high-performance model fitting the purpose of unauthorized act detection in a financial transaction.

Detailed examples of the model generation apparatus 300 will be described below.

### Seventh Example Embodiment

### <System Overview>

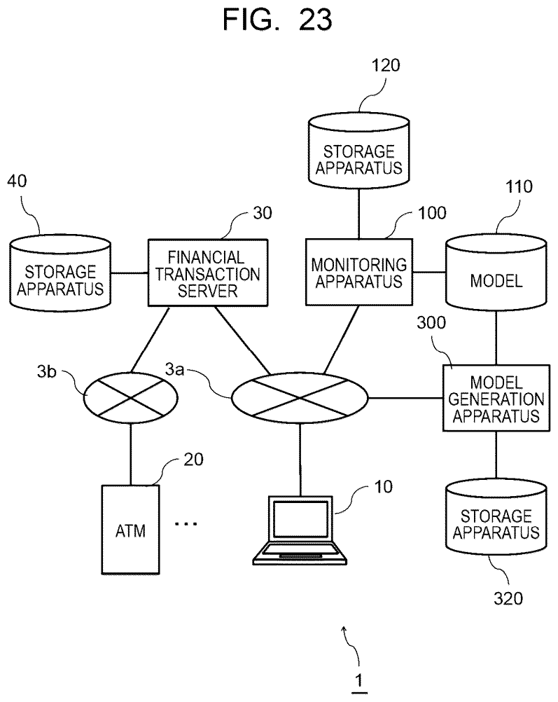

FIG. 23 is a diagram conceptually illustrating a system configuration of a monitoring system 1 according to an example embodiment. The monitoring system 1 in FIG. 23 further includes a model generation apparatus 300 in addition to the configuration of the monitoring system 1 in FIG. 3. In other words, the monitoring system 1 in FIG. 23 includes the model generation apparatus 300 in place of the model generation apparatus 200 in the monitoring system 1 in FIG. 13. The model generation apparatus 300 is connected to a financial transaction server 30 through a communication network 3a. Note that the configuration according to the present example embodiment may be combined with at least one of configurations according to other example embodiments without contradicting each other.

The model generation apparatus 300 includes a storage apparatus 320 and may also include a storage apparatus (unillustrated) that stores a model 110. The storage apparatus for the model 110 and the storage apparatus 320 may be provided inside the model generation apparatus 300 or may be provided outside the model generation apparatus 300. In other words, each of the storage apparatus for the model 110 and the storage apparatus 320 may be hardware integrated with the model generation apparatus 300 or hardware separate from the model generation apparatus 300.

The model generation apparatus 300 is implemented by a personal computer, a server computer, or the like.

The model generation apparatus 300 generates a model 110 detecting an unauthorized act in a financial transaction. The model generation apparatus 300 acquires information of the financial transaction server 30 and uses the information in generation of a model 110. The monitoring apparatus 100 monitors financial transactions by using the model 110 generated by the model generation apparatus 300.

A program for generating a model 110 is installed on a computer 1000 implementing the model generation apparatus 300. Each function of each component in the model generation apparatus 300 is provided by execution of the program. Further, an operation terminal 10 may function as an operation terminal of the model generation apparatus 300; and the model generation apparatus 300 may function as a server connected to each operation terminal 10 through the communication network 3a, and the operation terminal 10 may function as a client terminal.

Similarly to the aforementioned example embodiment, at least one of the model generation apparatus 300 and the operation terminal 10 is previously authorized to utilize the monitoring system 1, and a person in charge who uses the model generation apparatus 300 and the operation terminal 10 previously acquires account information for logging into the monitoring system 1 (such as a username and a password). Further, an application program for utilizing a service provided by the monitoring system 1 is preinstalled on each of the model generation apparatus 300 and the operation terminal 10, and by logging into the monitoring system 1 by using the account information after starting the program, various operation screens can be displayed from a menu screen (unillustrated) on the monitoring system 1. An operator can generate a model 110 by operating the various screens.

### <Functional Configuration Example>

A functional configuration of the model generation apparatus 300 will be described below by using FIG. 11.

A template information acquisition unit 302 acquires template information 380 used in generation of a model 110 detecting an unauthorized transaction in a financial transaction.

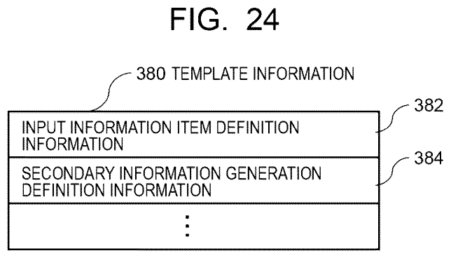

FIG. 24 is a diagram illustrating a data structure of the template information 380. The template information 380 includes various types of information defining a template 360. The template information 380 of the template 360 is stored in the storage apparatus 320.

The template information 380 at least includes input information item definition information 382 determining an item in each piece of input information used in generation of a model 110 and secondary information generation definition information 384 determining a generation content of secondary information contributing to improved performance of the model 110 based on the input information.

For each item determined by the input information item definition information 382 included in the template information 380, an input information acquisition unit 304 acquires input information corresponding to the item.

For example, when data files of transaction information 400, customer information 410, and account information 420 that are described in the aforementioned example embodiment are imported, the input information item definition information 382 determines information of an item (a column in one transaction record) to be input out of the pieces of information (data files).

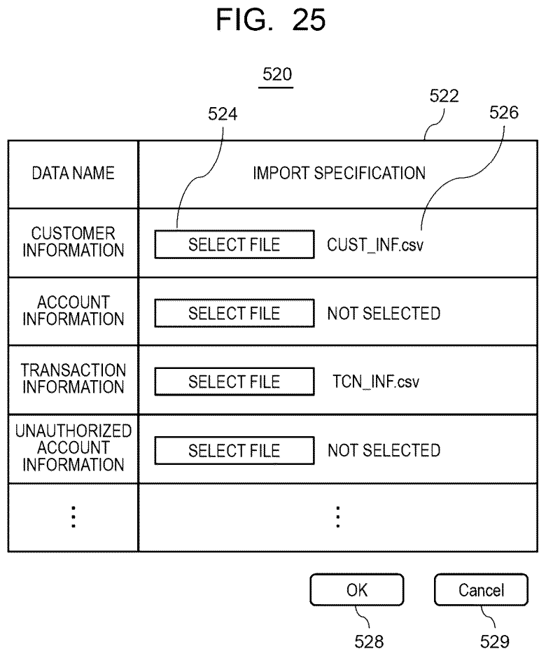

When selection of “IMPORT DATA FILE” is accepted on a menu screen in the model generation apparatus 300, an import screen 520 is displayed on a display. FIG. 25 is a diagram illustrating an example of the import screen 520. The import screen 520 includes a file specification list 522, an OK button 528, and a cancel button 529.

The file specification list 522 includes a column for a name of data to be imported and a column specifying a file of the data. The file specification column includes a file selection button 524 and a selected file display part 526. When accepting depression of the file selection button 524, the model generation apparatus 300 can allow an operator to select a data file by opening a window for reference to a data folder. A selected data file name is displayed in the selected file display part 526.

When accepting depression of the OK button 528, the model generation apparatus 300 finalizes file specification of imported data and ends the menu. When accepting depression of the cancel button 529, the model generation apparatus 300 cancels file specification of imported data and ends the menu.

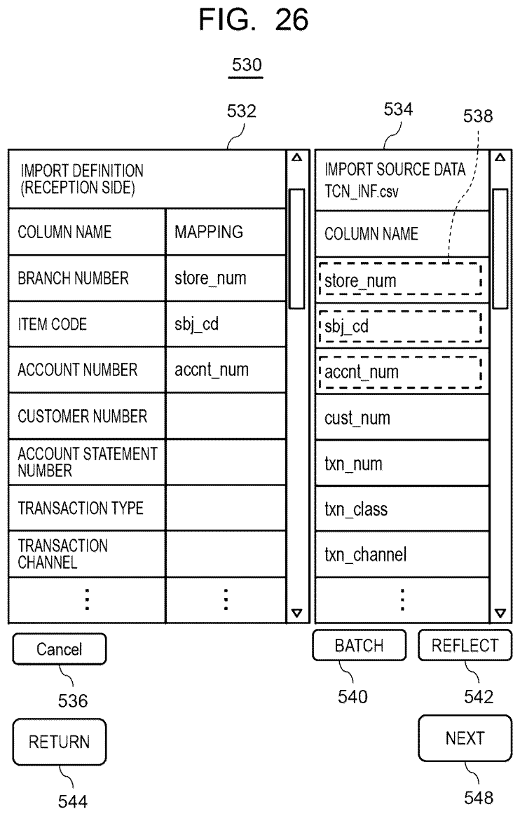

Next, when selection of “INPUT INFORMATION ITEM DEFINITION” is accepted on the menu screen in the model generation apparatus 300, an input information selection screen 530 is displayed on the display. FIG. 26 is a diagram illustrating an example of the input information selection screen 530. The diagram illustrates an example of the input information selection screen 530 for selecting a data item (a column in a record of one transaction) to be an input target out of data items in the transaction information 400. In other words, the input information selection screen 530 may be considered a screen for accepting selection of excluding a data item not used in generation of a model 110 out of data items in the transaction information 400.

The input information selection screen 530 is a screen for accepting a selection operation of a data item being an input target acquired by the input information acquisition unit 304, generating input information item definition information 382, including the generated information into the template information 380, and storing the resulting information into the storage apparatus 320. The input information selection screen 530 includes an import definition information list 532, an import source data list 534, a return button 544, and a next button 548.

A data item being an input target can be mapped to import source data by using the import definition information list 532 and the import source data list 534. It is assumed that data items in the import definition information list 532 and the same data items in the import source data list 534 are previously displayed side by side in the same order.

When an operation of a scroll bar in one list is accepted, the other list may scroll together or may not scroll together: or either operation may be selectively set.

Further, in a case where data items in the import definition information list 532 and the import source data list 534 do not match, the model generation apparatus 300 may first make an association between data items in the import destination and the import source by accepting selection (by an operator) of a cell in a mapping column in the import definition information list 532 for a data item (a column in a record of one transaction) being an input target and then accepting selection (by the operator) of a data item (source data) in a data file in the import source (the import source data list 534) corresponding to the selected data item.

The example in this diagram will be described on an assumption that data items in the import definition information list 532 and the import source data list 534 match.

A data name (a column name in a record of one transaction) of each item (such as store_num or sbj_cd) in a data file in the import source (a data file “TON_INF.csv” specified to be imported as transaction information 400 in this case) is displayed in the import source data list 534.

The model generation apparatus 300 can accept selection of a data item (a column name in a record of one transaction) being an input target to be acquired by the input information acquisition unit 304 by depression of a cell in the import source data list 534 by the operator.

A cell of a selected data item is set to a selected display 538. While the selected display 538 is not particularly limited as long as a display method of notifying the operator that the data item has been selected is employed, for example, the background of the cell may be changed, the text color in the cell may be changed, or the cell may be highlighted.

The input information selection screen 530 further includes a batch selection button 540 and a reflection button 542. When accepting depression of the batch selection button 540, the model generation apparatus 300 sets all data items in an import source data file in the import source data list 534 to a selection state in one batch and sets cells of all data items to the selected display 538. In other words, by depressing the batch selection button 540, the operator can bypass the aforementioned selection operation for each data item. Further, as for cells in a batch selected state for which depression by the operator is accepted, selection may be canceled on a per cell basis.

When accepting depression of the reflection button 542, the model generation apparatus 300 causes a data item of a cell set to the selected display 538 in the import source data list 534 to be mapped to a data item in a corresponding row in the import definition information list 532, and thus a data name is displayed in each cell in the mapping column in the import definition information list 532.

For example, a data name of an item selected in the import source data list 534, such as “store_num,” is displayed in a mapping column for a data item “BRANCH NUMBER” in the import definition information list 532 by depression of the reflection button 542. The example in this diagram illustrates a state of the top three data items being selected as input targets and being mapped to the import definition information list 532.

When accepting depression of the return button 544, the model generation apparatus 300 cancels the data item selection operation accepted on the screen 530 (deletes the selected display 538) and returns to the menu screen. When accepting depression of the next button 548, the model generation apparatus 300 includes input information item definition information 382 defining a data item selected in the import source data list 534 as an input target into the template information 380, based on map information reflected in the import definition information list 532, and stores the resulting information into the storage apparatus 320.

Note that the input information selection screen 530 similarly allows selection and specification for the customer information 410 and the account information 420; and the template information 380 including information defined in the input information item definition information 382 for each type of information may be stored into the storage apparatus 320.

For each item determined by the input information item definition information 382, the input information acquisition unit 304 acquires input information corresponding to the item by using the thus defined input information item definition information 382.

Next, a control unit 306 controls a generation content of secondary information 440 according to the secondary information generation definition information 384 included in the template information.

For example, in a case where the data file of the secondary information 440 described in the aforementioned example embodiment is imported, the secondary information generation definition information 384 defines information of an item (a column in one transaction record) to be (or not to be) generated for use as an explanatory variable in a data file of each piece of secondary information 440.

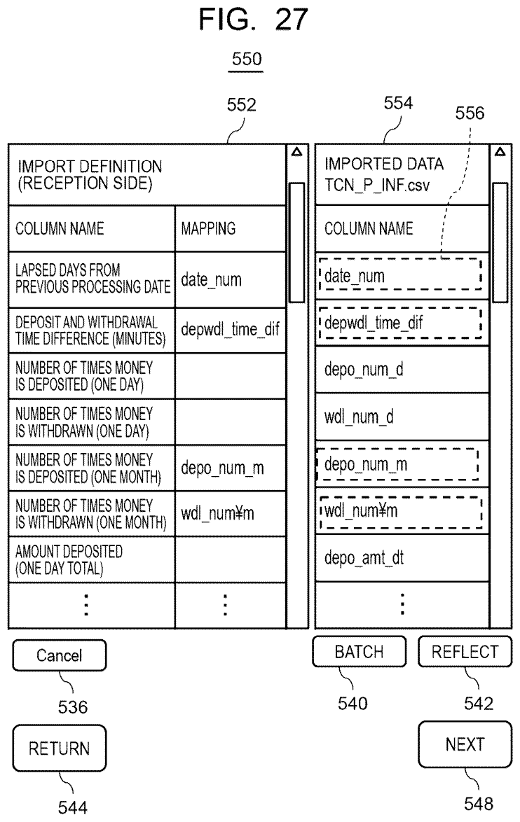

When selection of “SECONDARY INFORMATION GENERATION DEFINITION” is accepted on the menu screen in the model generation apparatus 300, a secondary information selection screen 550 is displayed on the display: FIG. 27 is a diagram illustrating an example of the secondary information selection screen 550. The diagram illustrates an example of the secondary information selection screen 550 for selecting a data item (a column in one record) used as an explanatory variable out of data items in the intra-period transaction information 442 in FIG. 14 in the secondary information 440. In other words, the secondary information selection screen 550 may be considered a screen for accepting selection of excluding a data item not used in generation of a model 110 out of data items in the secondary information 440.

The secondary information selection screen 550 is a screen for accepting a generation content of secondary information 440 controlled by the control unit 306, a selection operation of a data item to be used as an explanatory variable in the secondary information 440 in this case, generating secondary information generation definition information 384, including the generated information into the template information 380, and storing the resulting information into the storage apparatus 320. The secondary information selection screen 550 includes a cancel button 536, a batch selection button 540, a reflection button 542, a return button 544, and a next button 548 that are the same as those in the input information selection screen 530 in FIG. 26.

The secondary information selection screen 550 further includes an import definition information list 552 and an import source data list 554. Mapping of a data item in the import source data list 554 imported as a data item used as an explanatory variable can be performed by using the import definition information list 552 and the import source data list 554. It is assumed that data items in the import definition information list 552 and the same data items in the import source data list 554 are previously displayed side by side in the same order.

When an operation of a scroll bar in one list is accepted, the other list may scroll together or may not scroll together: or either operation may be selectively set.

Further, in a case where data items in the import definition information list 552 and the import source data list 554 do not match, the model generation apparatus 300 may first make an association between data items in the import destination and the import source by accepting selection (by an operator) of a cell in a mapping column in the import definition information list 552 for a data item (a column in a record of one transaction) being an input target and then accepting selection (by the operator) of a data item (source data) in a data file in the import source (the import source data list 554) corresponding to the selected data item.

The example in this diagram will be described on an assumption that data items in the import definition information list 552 and the import source data list 554 match.

A data name (a column name in one record) of each item (such as date_num or depwdl_time_dif) in a data file (a data file “TON_P_INF.csv” specified to be imported as secondary information 440 in this case) in the import source is displayed in the import source data list 554.

The model generation apparatus 300 can accept selection of a data item (a column name in one record) being a generation target as an explanatory variable in the secondary information 440 by depression of a cell in the import source data list 554 by the operator.

A cell of a selected data item is set to a selected display 556. While the selected display 556 is not particularly limited as long as a display method of notifying the operator that the data item is selected is employed, for example, the background of the cell may be changed, the text color in the cell may be changed, or the cell may be highlighted.

When accepting depression of the reflection button 542, the model generation apparatus 300 causes a data item for a cell set to the selected display 556 in the import source data list 554 to be mapped to a data item in a corresponding row in the import definition information list 552, and thus a data name is displayed in each cell in the mapping column in the import definition information list 552.

For example, a data name of an item selected in the import source data list 554, such as “date_num,” is displayed in a mapping column for a data item “LAPSED DAYS FROM PREVIOUS PROCESSING DATE” in the import definition information list 552 by depression of the reflection button 542. The example in this diagram illustrates a state of four data items being selected as generation targets of secondary information 440 and being mapped to the import definition information list 552.

When accepting depression of the next button 548, the model generation apparatus 300 includes secondary information generation definition information 384 including secondary information item definition information determining a data item selected in the import source data list 554 into the template information 380, based on mapping information reflected in the import definition information list 552, and stores the resulting information into the storage apparatus 320.

Thus, the secondary information generation definition information 384 includes the secondary information item definition information determining definition information determining an item in secondary information 440 to be generated.

Note that the secondary information selection screen 550 similarly allows selection and specification for other types of secondary information 440; and template information 380 including information defined in the secondary information generation definition information 384 for each type of information may be stored in the storage apparatus 320. Accordingly, the secondary information item definition information in the secondary information generation definition information 384 may be information defining a data item for each data file indicating the different type of secondary information 440.

The control unit 306 controls a generation content of secondary information 440 according to the thus defined secondary information generation definition information 384.

Then, the model generation unit 308 generates a model 110, based on the generation content of the secondary information 440 controlled by the control unit 306. In other words, the model generation unit 308 generates a model 110 using secondary information 440 defined by the secondary information generation definition information 384.

The model generation apparatus 300 includes the template information acquisition unit 302, the input information acquisition unit 304, the control unit 306, and the model generation unit 308. The template information acquisition unit 302 acquires template information used in generation of a model 110 detecting an unauthorized transaction in a financial transaction. The template information includes input information item definition information determining an item in each piece of input information used in generation of a model 110 and secondary information generation definition information determining a generation content of secondary information contributing to improved performance of the model 110 based on the input information. For each item determined by the input information item definition information included in the template information, the input information acquisition unit 304 acquires input information corresponding to the item. The control unit 306 controls a generation content of secondary information according to the secondary information generation definition information included in the template information. The model generation unit 308 generates a model 110, based on the controlled generation content of the secondary information.

The model generation apparatus 300 can easily generate a high-performance model fitting the purpose of unauthorized act detection in a financial transaction.

### Eighth Example Embodiment

A model generation apparatus 300 according to the present example embodiment is similar to the aforementioned seventh example embodiment in FIG. 21 except for including a configuration in which a model 110 is generated by selecting template information 380 from among a plurality of pieces of template information 380 in which different explanatory variables are defined. The model generation apparatus 300 according to the present example embodiment includes a configuration similar to that in FIG. 21 and therefore will be described by using FIG. 21.

### <Functional Configuration Example>

When accepting input of selecting one piece of template information 380 out of a plurality of pieces of template information 380 between which at least one of a generation content of secondary information 440 determined by secondary information generation definition information 384 and an item determined by input information item definition information 382 is different, a template information acquisition unit 302 acquires the selected template information 380.

For example, each of pieces of template information 380 between which at least one of definition contents of input information item definition information 382 and secondary information generation definition information 384 that are defined by the model generation apparatus 300 according to the aforementioned seventh example embodiment is different may be named and stored.

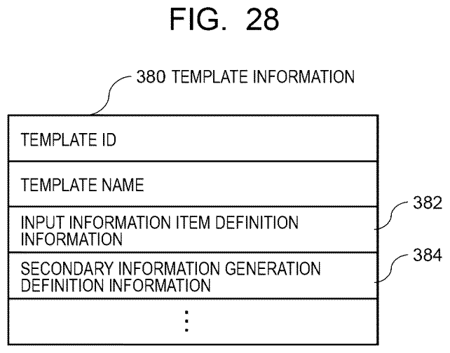

FIG. 28 is a diagram illustrating a data structure example of the template information 380. The template information 380 in FIG. 28 further includes a template ID for identifying a template 360 and a template name in addition to the input information item definition information 382 and the secondary information generation definition information 384 in the template information 380 in FIG. 24. Specifically, a template ID and a template name, and the input information item definition information 382 and the secondary information generation definition information 384 that are defined in the seventh example embodiment are stored in association with each other in each of pieces of template information 380 between which at least either of the input information item definition information 382 and the secondary information generation definition information 384 is different.

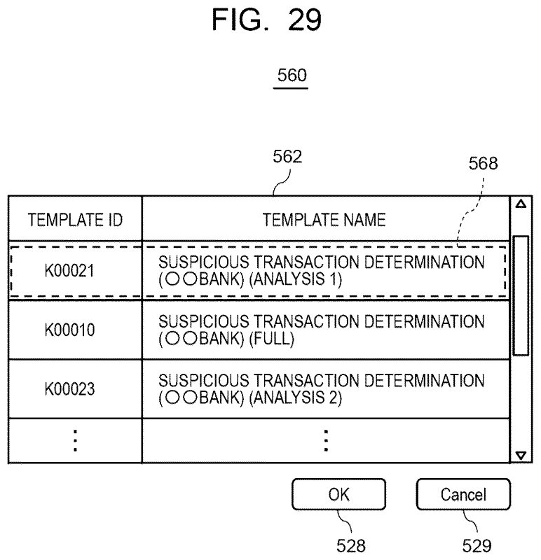

When selection of “TEMPLATE SELECTION” is accepted on a menu screen in the model generation apparatus 300, a template selection screen 560 is displayed on a display. FIG. 29 is a diagram illustrating an example of the template selection screen 560. The template selection screen 560 includes an OK button 528 and a cancel button 529 that are the same as those in FIG. 25 and also includes a template list 562.

The template list 562 displays template IDs and template names of a plurality of pieces of template information 380 in list form. For example, a model 110 allowing an analysis (indicated as a template name “ANALYSIS 1” or “ANALYSIS 2” in the diagram) with varying explanatory variables for unauthorized act detection in a financial transaction can be generated according to a generation content of secondary information 440 determined by secondary information generation definition information 384. Further, a template 360 including “(FULL)” in the template name in the diagram indicates that, for example, all data items in the secondary information 440 are included without exclusion.

When a template 360 used in generation of a model 110 is selected from the template list 562, the row of the selected template 360 is set to a selected display 568. While the selected display 568 is not particularly limited as long as a display method of notifying an operator that the template 360 has been selected is employed, for example, the background of the cell may be changed, the text color in the cell may be changed, or the cell may be highlighted.

The template selection screen 560 may further include a search key input part (unillustrated) and a search button (unillustrated). The model generation apparatus 300 may accept at least part of a template ID or a template name of a template input to the search key input part as a search key and be able to display, in the template list 562, template information 380 acquired by searching registered pieces of template information 380.

When accepting depression of the OK button 528, the model generation apparatus 300 reads template information 380 of a selected template 360 from a storage apparatus 320. The model generation apparatus 300 generates a model 110 by using the template information 380.

A model generation unit 308 may further generate a model 110, based on input information acquired by an input information acquisition unit 304.

### <Operation Example>

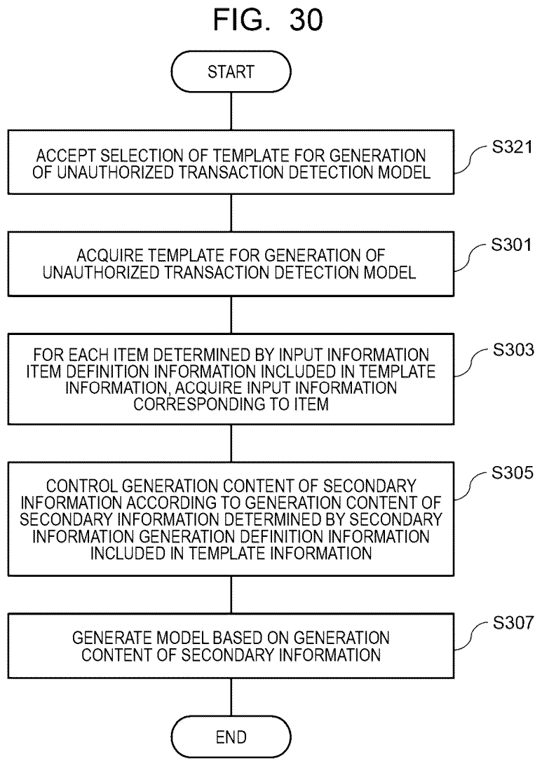

FIG. 30 is a flowchart illustrating an operation example of the model generation apparatus 300 according to the example embodiment.

The flow in FIG. 30 includes Step S301 to Step S307 that are the same as those in the flow in FIG. 23 and further includes Step S321 before Step S301.

First, the template information acquisition unit 302 accepts a selection operation of a template 360 and depression of the OK button 528 by an operator on the template selection screen 560 in FIG. 29 (Step S321). When accepting depression of the OK button 528, the template information acquisition unit 302 acquires template information 380 of a template 360 set to the selected display 568 in the template list 562 by reading the information from the storage apparatus 320 (Step S301).

The processing in and after Step S303 is similar to that in FIG. 23.

The template information 380 may further include algorithm definition information 386 determining a generation algorithm of a model 110.

The model generation unit 308 generates a model 110, based on a generation algorithm determined by the algorithm definition information 386.

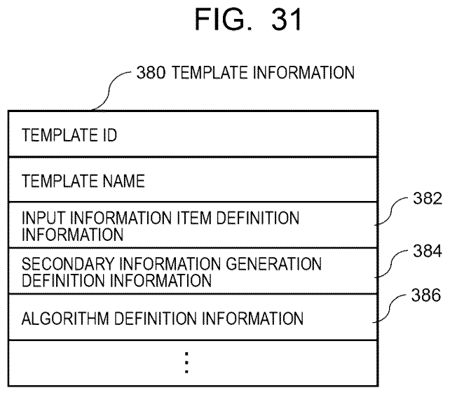

FIG. 31 is a diagram illustrating a data structure example of the template information 380.

The template information 380 in FIG. 31 further includes algorithm definition information 386 in addition to the data items in the template information 380 in FIG. 28.

While examples of a conceivable generation algorithm determined by the algorithm definition information 386 include heterogeneous mixture, logistic regression, a multilayer perceptron, and gradient boosting, another algorithm may be employed.

When accepting selection of “ALGORITHM SELECTION” on the menu screen, the model generation apparatus 300 may display an algorithm selection screen (unillustrated) on the display: The algorithm selection screen includes a user interface (UI) for accepting selection of an algorithm. When accepting selection of an algorithm by an operator, the model generation apparatus 300 defines the selected algorithm in the algorithm definition information 386, includes the information into the template information 380, and stores the resulting information into the storage apparatus 320. Template information 380 of algorithm definition information 386 in which a different algorithm is defined may be stored into the storage apparatus 320 as a separate piece of template information 380 in association with a new template ID and a new template name.

The model generation unit 308 generates a model 110, based on an algorithm defined in the algorithm definition information 386.

The control unit 306 determines whether to generate secondary information 440 depending on a generation content of secondary information 440 determined by the secondary information generation definition information 384 and performs control of generating secondary information 440 in a case where it is determined to generate secondary information 440.

Specifically, in a case where a generation content of secondary information 440 is defined in the secondary information generation definition information 384 (a data item in secondary information 440 is selected on the secondary information selection screen 550 in FIG. 27), the template information 380 may include secondary information generation definition information 384. In other words, in a case where a generation content of secondary information 440 is not defined on the secondary information selection screen 550 in FIG. 27, the template information 380 may not include the secondary information generation definition information 384.

The control unit 306 may determine to control generation of secondary information 440 in a case where the secondary information generation definition information 384 is included in the template information 380 and may determine not to control generation of secondary information 440 in a case where the secondary information generation definition information 384 is not included in the template information 380.

As another example, the secondary information generation definition information 384 may include a flag indicating whether a generation content of secondary information 440 is defined on the secondary information selection screen 550 in FIG. 27. The control unit 306 refers to the flag in the secondary information generation definition information 384, determines to control generation of secondary information 440 in a case where the flag indicates that a generation content of secondary information 440 is defined, and determines not to control generation of secondary information 440 in a case where the flag indicates that a generation content of secondary information 440 is not defined.

The control unit 306 determines whether to generate secondary information 440 depending on a generation content of secondary information 440 determined by the secondary information generation definition information 384 and does not perform control of generating secondary information 440 in a case where it is determined not to generate secondary information 440.

### <Operation Example>

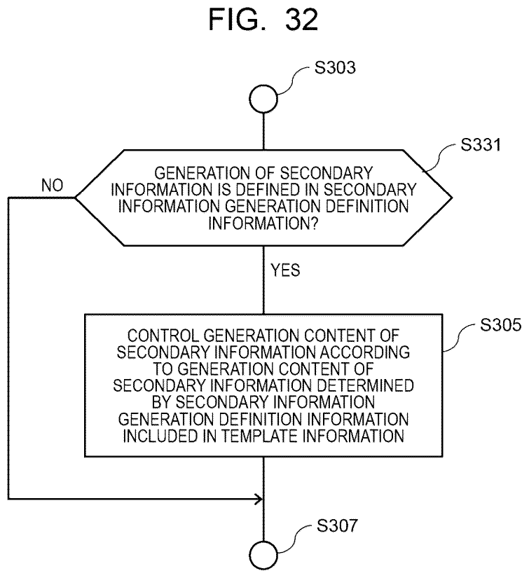

FIG. 32 is a flowchart illustrating a main part of an operation example of the model generation apparatus 300 according to the example embodiment. The flow in FIG. 32 is executed after Step S303 in FIG. 22 or FIG. 30 in the model generation apparatus 300 according to the aforementioned example embodiment. In Step S303, for each item determined by input information item definition information included in template information acquired in Step S301, the input information acquisition unit 304 acquires input information corresponding to the item. Then, the control unit 306 determines whether to generate secondary information 440 depending on a generation content of secondary information 440 determined by the secondary information generation definition information 384 (Step S331).

Then, in a case where secondary information 440 is determined not to be generated (NO in Step S331), the control unit 306 does not perform control of generating secondary information 440. Specifically; the control unit 306 bypasses Step S305 and advances to Step S307. In this case, the model generation unit 308 does not generate secondary information 440 and generates a model 110, based on input information acquired by the input information acquisition unit 304 in Step S303 (Step S307).

On the other hand, in a case where secondary information 440 is determined to be generated (YES in Step S331), the control unit 306 performs control of generating secondary information 440. Specifically, the control unit 306 advances to Step S305 and controls a generation content of secondary information according to secondary information generation definition information included in template information acquired in Step S301. In other words, the control unit 306 generates secondary information 440.

Then, the model generation unit 308 generates a model 110 by using the secondary information 440 generated in Step S305 (Step S307). Note that the model generation unit 308 may generate a model 110, based on input information acquired by the input information acquisition unit 304 in Step S303 in addition to the secondary information 440 in this case as well.

As described above, when accepting input of selecting one piece of template information 380 out of a plurality of pieces of template information 380 between which at least one of a generation content of secondary information 440 determined by secondary information generation definition information 384 and an item determined by input information item definition information 382 is different, the template information acquisition unit 302 according to the present example embodiment acquires the selected template information 380.

Thus, the model generation apparatus 300 according to the present example embodiment provides effects similar to those of the aforementioned example embodiments and can further generate a model 110 by selecting template information 380 from among a plurality of pieces of template information 380 in which different explanatory variables are defined and therefore can perform efficient unauthorized act detection in a financial transaction by appropriately selecting previously prepared template information 380 according to a detection target. Further, the model generation apparatus 300 can perform unauthorized act detection in a financial transaction by using an explanatory variable suited to a detection content and therefore can generate a model 110 that can further improve unauthorized act detection performance.

While the example embodiments of the present invention have been described above with reference to the drawings, the example embodiments are exemplifications of the present invention, and various configurations other than those described above may also be employed. For example, the secondary information generation definition information 384 may not only be defined by determining an item in secondary information 440 but also be defined by using a logical formula, such as a logical sum or a logical sum, related to a plurality of items in secondary information 440.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, at least one process may be performed by another operating entity such as another apparatus or person. Further, the aforementioned example embodiments may be combined without contradicting each other.

While the present invention has been described above with reference to the example embodiments, the present invention is not limited to the aforementioned example embodiments. Various changes and modifications that may be understood by a person skilled in the art may be made to the configurations and details of the present invention, within the scope of the present invention.

Note that when information about a user (such as a customer of a financial institution or a counterparty of a financial transaction by the institution) is acquired and used in the present invention, the acquisition and the use are assumed to be performed legally.

The whole or part of the example embodiments disclosed above may also be described as, but not limited to, the following supplementary notes.

1. A monitoring apparatus including:
an input unit that inputs past transaction information, customer information being information about a customer, and account information being information about an account that are in a financial transaction;
a generation unit that, by using the transaction information, the customer information, and the account information that are input by the input unit, generates unauthorized transaction information being information about an unauthorized transaction by using a trained model; and
an output unit that outputs the unauthorized transaction information generated by the generation unit, wherein
the unauthorized transaction information includes at least one of an unauthorized transaction score by account and an unauthorized transaction score by customer.
   2. The monitoring apparatus according to 1., wherein
the unauthorized transaction information further includes an unauthorized transaction score by transaction.
   3. The monitoring apparatus according to 1, or 2., wherein
the output unit outputs basis information being a basis of generation of the unauthorized transaction information.
   4. A monitoring system including:
an input unit that inputs past transaction information, customer information being information about a customer, and account information being information about an account that are in a financial transaction;
a generation unit that, by using the transaction information, the customer information, and the account information that are input by the input unit, generates unauthorized transaction information being information about an unauthorized transaction by using a trained model; and
an output unit that outputs the unauthorized transaction information generated by the generation unit, wherein
the unauthorized transaction information includes at least one of an unauthorized transaction score by account and an unauthorized transaction score by customer.
   5. The monitoring system according to 4., wherein
the unauthorized transaction information further includes an unauthorized transaction score by transaction.
   6. The monitoring system according to 4, or 5., wherein
the output unit outputs basis information being a basis of generation of the unauthorized transaction information.
   7. A monitoring method including, by one or more computers:
inputting past transaction information, customer information being information about a customer, and account information being information about an account that are in a financial transaction;
by using the input transaction information, the input customer information, and the input account information, generating unauthorized transaction information being information about an unauthorized transaction by using a trained model; and
outputting the generated unauthorized transaction information, wherein
the unauthorized transaction information includes at least one of an unauthorized transaction score by account and an unauthorized transaction score by customer.
   8. The monitoring method according to 7., wherein
the unauthorized transaction information further includes an unauthorized transaction score by transaction.
   9. The monitoring method according to 7, or 8., further including, by the one or more computers,
outputting basis information being a basis of generation of the unauthorized transaction information.
   10. A program causing a computer to execute:
a procedure for inputting past transaction information, customer information being information about a customer, and account information being information about an account that are in a financial transaction;
a procedure for, by using the transaction information, the customer information, and the account information that are input by the inputting procedure, generating unauthorized transaction information being information about an unauthorized transaction by using a trained model; and
a procedure for outputting the unauthorized transaction information generated by the generating procedure, wherein
the unauthorized transaction information includes at least one of an unauthorized transaction score by account and an unauthorized transaction score by customer.
   11. The program according to 10., wherein
the unauthorized transaction information further includes an unauthorized transaction score by transaction.
   12. The program according to 10. or 11., wherein
basis information being a basis of generation of the unauthorized transaction information is output in the outputting procedure.
   13. A computer-readable storage medium on which a program is stored, the program causing a computer to execute:
a procedure for inputting past transaction information, customer information being information about a customer, and account information being information about an account that are in a financial transaction;
a procedure for, by using the transaction information, the customer information, and the account information that are input by the inputting procedure, generating unauthorized transaction information being information about an unauthorized transaction by using a trained model; and
a procedure for outputting the unauthorized transaction information generated by the generating procedure, wherein
the unauthorized transaction information includes at least one of an unauthorized transaction score by account and an unauthorized transaction score by customer.
   14. The storage medium according to 13., wherein
the unauthorized transaction information further includes an unauthorized transaction score by transaction.
   15. The storage medium according to 13. or 14., wherein
basis information being a basis of generation of the unauthorized transaction information is output in the outputting procedure.

### REFERENCE SIGNS LIST

1 Monitoring system
3a, 3b Communication network
10 Operation terminal
20 ATM
30 Financial transaction server
40 Storage apparatus
100 Monitoring apparatus
102 Input unit
104 Generation unit
106 Output unit
110 Model
120 Storage apparatus
200 Model generation apparatus
202 Secondary information generation unit
204 Model generation unit
206 Input unit
220 Storage apparatus
300 Model generation apparatus
302 Template information acquisition unit
304 Input information acquisition unit
306 Control unit
308 Model generation unit
320 Storage apparatus
360 Template
380 Template information
382 Input information item definition information
384 Secondary information generation definition information
386 Algorithm definition information
400 Transaction information
410 Customer information
420 Account information
430 Unauthorized transaction information
440 Secondary information
442 Intra-period transaction information
500 Screen
510 Basis information output screen
530 Input information selection screen
550 Secondary information selection screen
560 Template selection screen
1000 Computer
1010 Bus
1020 Processor
1030 Memory
1040 Storage device
1050 Input/output interface
1060 Network interface

What is claimed is:

1. A monitoring apparatus comprising:
at least one memory store instructions; and
at least one processor configured to execute the instructions to:
input past transaction information, customer information being information about a customer, and account information being information about an account that are in a financial transaction;
by using the transaction information, the customer information, and the account information that are input, generate unauthorized transaction information being information about an unauthorized transaction by using a trained model; and
output the unauthorized transaction information generated, wherein
the unauthorized transaction information includes at least one of an unauthorized transaction score by account and an unauthorized transaction score by customer.

2. The monitoring apparatus according to claim 1, wherein
the unauthorized transaction information further includes an unauthorized transaction score for each transaction.

3. The monitoring apparatus according to claim 1, wherein
the at least one processor is further configured to execute the instructions to output basis information being a basis of generation of the unauthorized transaction information.

4. (canceled)

5. A monitoring method comprising, by one or more computers:
inputting past transaction information, customer information being information about a customer, and account information being information about an account that are in a financial transaction;
by using the input transaction information, the input customer information, and the input account information, generating unauthorized transaction information being information about an unauthorized transaction by using a trained model; and
outputting the generated unauthorized transaction information, wherein
the unauthorized transaction information includes at least one of an unauthorized transaction score by account and an unauthorized transaction score by customer.

6. A non-transitory computer-readable storage medium on which a program is stored, the program causing a computer to execute:
a procedure for inputting past transaction information, customer information being information about a customer, and account information being information about an account that are in a financial transaction;
a procedure for, by using the transaction information, the customer information, and the account information that are input by the procedure for inputting, generating unauthorized transaction information being information about an unauthorized transaction by using a trained model; and
a procedure for outputting the unauthorized transaction information generated by the procedure for generating, wherein
the unauthorized transaction information includes at least one of an unauthorized transaction score by account and an unauthorized transaction score by customer.
